(19) United States
(12) Patent Application Publication
(10) Pub. No.: US 2025/0184074 A1
(43) Pub. Date: Jun. 5, 2025

(54) INFORMATION PROCESSING APPARATUS, INFORMATION PROCESSING METHOD, RECEPTION APPARATUS, AND RECEPTION METHOD

(71) Applicant: SONY GROUP CORPORATION, TOKYO (JP)

(72) Inventors: YUSUKE UMEZAWA, TOKYO (JP); MASANORI SATO, TOKYO (JP)

(21) Appl. No.: 18/842,480

(22) PCT Filed: Feb. 20, 2023
(86) PCT No.: PCT/JP2023/005916

§ 371 Date: Aug. 29, 2024

(30) Foreign Application Priority Data
Mar. 8, 2022 (JP) 2022-034937

(51) Int. Cl. H04L 5/00; G06N 20/00; H04W 56/00; H04W 72/0446

(52) U.S. Cl. CPC H04L 5/0051; G06N 20/00; H04W 56/0015; H04W 72/0446

(57) ABSTRACT

The present disclosure relates to an information processing apparatus, an information processing method, a reception apparatus, and a reception method capable of more effectively collecting learning data. Provided is an information processing apparatus including a data collection unit that collects supervised data of a frame that has failed to be demodulated as a single frame by using a deviation amount between a detection time and a transmission time of a frame that has been successfully demodulated as a single frame in a case where a deviation amount between a transmission time at a terminal and a reception time at a receiving station is constant between repeated frames. The present disclosure can be applied to, for example, devices used in the IoT area.

### TECHNICAL FIELD

The present disclosure relates to an information processing apparatus, an information processing method, a reception apparatus, and a reception method, and particularly relates to an information processing apparatus, an information processing method, a reception apparatus, and a reception method capable of more effectively collecting learning data.

### BACKGROUND ART

In an Internet of Things (IoT) area, since information is collected from a large number of sensor terminals, there is a high demand for services that can be used at low cost. Covering a wide area with a small number of receiving stations enables provision of services at low cost. In order to ensure a wide range of coverage, it is important to be able to correctly detect a target sensor signal from a reception signal in which an interference signal exists and to correctly demodulate a signal corresponding to a detected signal length.

Meanwhile, in recent years, machine learning has been actively studied in various fields. It has been reported that machine learning models having enormous parameters can be tuned by using a large amount of learning data due to improvement in computer performance, and thus the performance greatly exceeds the performance of the conventional method in recognition of images and sounds.

Considering a combination of a wireless system and a machine learning method, it is conceivable to secure a wide range of coverage by recognizing an interference signal and a target sensor signal and correctly detecting the target sensor signal by a method using machine learning in a receiving station.

In an IoT area, there are many wireless systems using an unlicensed band. In the unlicensed band, there are many wireless systems using various communication methods, and entry of a new wireless system is easy. Due to these factors, there is a possibility that the environment of the interference wave greatly varies depending on the place and time. By learning the reception signal at each receiving station using machine learning, it is possible to expect a wider range of coverage by constructing an optimal signal detector at a place and time when the receiving station is present.

For example, as a wireless system used in an IoT area, there is a system disclosed in Patent Document 1. Patent Document 1 discloses a position notification system for grasping a position of a position monitoring target.

### CITATION LIST

### Patent Document

Patent Document 1: WO 2017/212810 A

### SUMMARY OF THE INVENTION

### Problems to be Solved by the Invention

In a case where a machine learning method is used, it is important to collect a large amount of learning data. In particular, in a wireless system, a system that automatically collects a large amount of learning data from reception signals is essential in order to configure an optimal receiver at each place and each time in an environment in which unknown interference signals different for each installation place of the receiving station change depending on the period.

The present disclosure has been made in view of such a situation, and enables more effective collection of learning data.

### Solutions to Problems

An information processing apparatus according to one aspect of the present disclosure is an information processing apparatus including a data collection unit that collects supervised data of a frame that has failed to be demodulated as a single frame by using a deviation amount between a detection time and a transmission time of a frame that has been successfully demodulated as a single frame in a case where a deviation amount between a transmission time at a terminal and a reception time at a receiving station is constant between repeated frames.

An information processing method according to one aspect of the present disclosure is an information processing method in which an information processing apparatus is configured to collect supervised data of a frame that has failed to be demodulated as a single frame by using a deviation amount between a detection time and a transmission time of a frame that has been successfully demodulated as a single frame in a case where a deviation amount between a transmission time at a terminal and a reception time at a receiving station is constant between repeated frames.

In the information processing apparatus and the information processing method according to one aspect of the present disclosure, in a case where the deviation amount between the transmission time at the terminal and the reception time at the receiving station is constant between repeated frames, supervised data of a frame that has failed to be demodulated as a single frame is collected by using the deviation amount between the detection time and the transmission time of a frame that has been successfully demodulated as a single frame.

A reception apparatus according to one aspect of the present disclosure is a reception apparatus configured as a receiving station that receives a radio signal from one or more terminals, the reception apparatus including a control unit that performs control to demodulate a frame by using a reception signal from the terminal as an input and an output from a frame detector that outputs a time at which a frame exists, in which the frame detector is learned using a learning data set including supervised data, and the supervised data is supervised data of a frame that has failed to be demodulated as a single frame, and is collected by using a deviation amount between a detection time and a transmission time of a frame that has been successfully demodulated as a single frame in a case where a deviation amount between a transmission time at the terminal and a reception time at the receiving station is constant between repeated frames.

A reception method according to one aspect of the present disclosure is a reception method in which a reception apparatus configured as a receiving station that receives a radio signal from one or more terminals is configured to perform control to demodulate a frame by using a reception signal from the terminal as an input and an output from a frame detector that outputs a time at which a frame exists, in which the frame detector is learned using a learning data set including supervised data, and the supervised data is supervised data of a frame that has failed to be demodulated as a single frame, and is collected by using a deviation amount between a detection time and a transmission time of a frame that has been successfully demodulated as a single frame in a case where a deviation amount between a transmission time at the terminal and a reception time at the receiving station is constant between repeated frames.

In the reception apparatus and the reception method according to one aspect of the present disclosure, control is performed to demodulate a frame by using a reception signal from the terminal as an input and an output from a frame detector that outputs a time at which a frame exists. Further, the frame detector is learned by using a learning data set including supervised data, and the supervised data is supervised data of a frame that has failed to be demodulated as a single frame, and is collected by using a deviation amount between a detection time and a transmission time of a frame that has been successfully demodulated as a single frame in a case where a deviation amount between a transmission time at the terminal and a reception time at the receiving station is constant between repeated frames.

Note that the information processing apparatus and the reception apparatus according to one aspect of the present disclosure may be independent apparatuses or may be internal blocks constituting one apparatus.

### BRIEF DESCRIPTION OF DRAWINGS

FIG. 1 is a block diagram illustrating a configuration example of a system to which the present disclosure is applied.

FIG. 2 is a block diagram illustrating a configuration example of a receiving station and a server in FIG. 1.

FIG. 3 is a diagram illustrating a deviation amount between a frame transmission time and a frame reception time.

FIG. 4 is a diagram illustrating a sequence of the entire system.

FIG. 5 is a diagram illustrating details of DT frame reception processing.

FIG. 6 is a flowchart for explaining a flow of reception result list generation processing.

FIG. 7 is a diagram illustrating a first example of a reception result list.

FIG. 8 is a flowchart for explaining a flow of a first example of data collection processing.

FIG. 9 is a flowchart for explaining a flow of relearning processing.

FIG. 10 is a diagram illustrating a second example of a reception result list.

FIG. 11 is a flowchart for explaining a flow of a second example of data collection processing.

FIG. 12 is a flowchart for explaining a flow of a second example of data collection processing.

FIG. 13 is a diagram illustrating a third example of a reception result list.

FIG. 14 is a flowchart for explaining a flow of a third example of data collection processing.

FIG. 15 is a flowchart for explaining a flow of a third example of data collection processing.

FIG. 16 is a diagram illustrating a deviation amount between a frame transmission time and a frame reception time.

FIG. 17 is a diagram illustrating a fourth example of a reception result list.

FIG. 18 is a flowchart for explaining a flow of a fourth example of data collection processing.

FIG. 19 is a flowchart for explaining a flow of a fourth example of data collection processing.

FIG. 20 is a diagram illustrating a fifth example of a reception result list.

FIG. 21 is a flowchart for explaining a flow of a fifth example of data collection processing.

FIG. 22 is a flowchart for explaining a flow of a fifth example of data collection processing.

FIG. 23 is a diagram illustrating a deviation amount between a frame transmission time and a frame reception time.

FIG. 24 is a diagram illustrating a sixth example of a reception result list.

FIG. 25 is a flowchart for explaining a flow of a sixth example of data collection processing.

FIG. 26 is a diagram illustrating a seventh example of a reception result list.

FIG. 27 is a flowchart for explaining a flow of a seventh example of data collection processing.

FIG. 28 is a block diagram illustrating a configuration example of hardware of a computer.

### MODE FOR CARRYING OUT THE INVENTION

### First Embodiment

### <System Configuration>

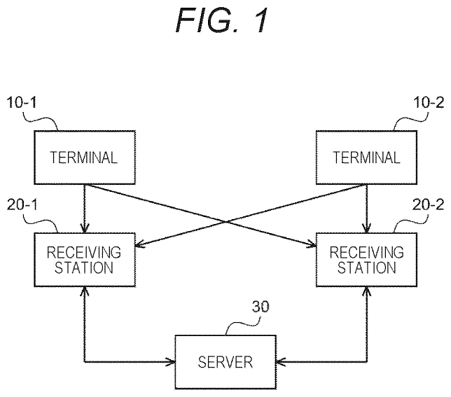

FIG. 1 is a diagram for explaining a configuration example of a system to which the present disclosure is applied.

As illustrated in FIG. 1, a system to which the present disclosure is applied includes a terminal 10-1, a terminal 10-2, a receiving station 20-1, a receiving station 20-2, and a server 30. The receiving station 20-1 and the receiving station 20-2 are examples of a reception apparatus to which the present disclosure is applied. The server 30 is an example of an information processing apparatus to which the present disclosure is applied.

The terminal 10-1 is a transmission terminal equipped with a sensor and a GPS receiver. As the sensor, a temperature sensor, a position sensor, or the like is used according to the application. The GPS receiver receives a GPS signal, acquires time information, and performs time synchronization between the transceivers. The global positioning system (GPS) is an example of a global navigation satellite system (GNSS), and other positioning systems may be used.

The terminal 10-1 performs wireless transmission of information (sensor information) acquired by the sensor periodically (for example, once every three minutes). The wireless transmission is performed as broadcast transmission that does not designate a receiver.

The terminal 10-2 is a transmission terminal configured similarly to the terminal 10-1. The terminal 10-2 performs wireless transmission (broadcast transmission) of the sensor information acquired by the sensor periodically.

The receiving station 20-1 is installed at an arbitrary place and receives radio signals transmitted from the terminal 10-1 and the terminal 10-2. The receiving station 20-1 processes the received radio signal and transmits information obtained as a result of the processing to the server 30.

The receiving station 20-2 is installed at a place different from the receiving station 20-1, and receives radio signals transmitted from the terminal 10-1 and the terminal 10-2. The receiving station 20-2 processes the received radio signal and transmits information obtained as a result of the processing to the server 30.

The server 30 receives information transmitted from the receiving station 20-1 and the receiving station 20-2. The server 30 performs various types of processing on the basis of the received information. For example, the server 30 manages the terminal ID included in the received information, and transmits an instruction of the terminal ID of the terminal to receive the radio signal to the receiving station 20-1 or the receiving station 20-2. Furthermore, the server 30 can collect the sensor information acquired by the terminal 10-1 and the terminal 10-2.

Although two terminals 10 of the terminal 10-1 and the terminal 10-2 are illustrated in FIG. 1, one or three or more terminals 10 may be provided. In addition, although two receiving stations 20 of the receiving station 20-1 and the receiving station 20-2 are illustrated, one or three or more receiving stations 20 may be provided. Furthermore, although one server 30 is illustrated, two or more servers 30 may be provided.

That is, a system to which the present disclosure is applied includes one or more terminals 10, one or more receiving stations 20, and one or more servers 30. Hereinafter, in a case where it is not necessary to distinguish the terminals including the terminal 10-1 and the terminal 10-2, they are referred to as the terminal 10. In a case where it is not necessary to distinguish the receiving stations including the receiving station 20-1 and the receiving station 20-2, they are referred to as receiving stations 20.

In FIG. 1, one or more terminals 10 and one or more receiving stations 20 constitute a wireless system. A method of transmitting and receiving a radio signal between the terminal 10 and the receiving station 20 is arbitrary, and various communication methods can be used. For example, a chirp-modulated signal can be transmitted and received using an unlicensed band such as a 920 MHz band in Japan. The wireless system can be used in the IoT area.

Furthermore, in FIG. 1, one or more receiving stations 20 and the server 30 are communicably connected via an arbitrary communication network. The communication network may include a wired communication network, a wireless communication network, or both of them. The communication network may include one communication network or a plurality of communication networks. For example, the communication network includes the Internet, a public telephone line network, a wide area communication network for a wireless mobile body, a wide area network (WAN), a local area network (LAN), and the like.

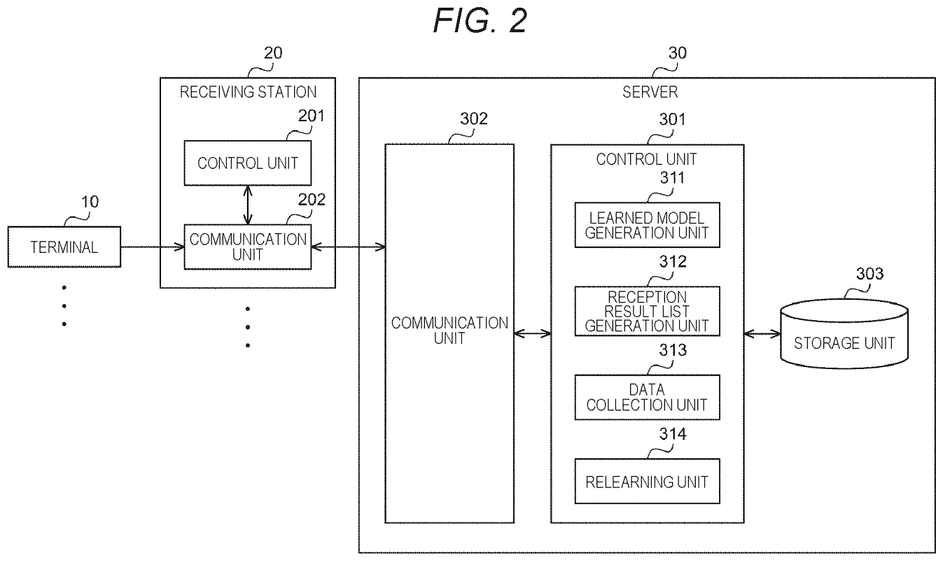

FIG. 2 is a block diagram illustrating a configuration example of the receiving station 20 and the server 30 in FIG. 1.

The receiving station 20 includes a control unit 201 and a communication unit 202.

The control unit 201 includes a processor such as a central processing unit (CPU). The control unit 201 controls operation of each unit of the receiving station 20.

The communication unit 202 is a communication circuit having a communication function with the terminal 10 and a communication function with the server 30. Although the communication circuits are grouped for convenience of description, a communication circuit having a communication function with the terminal 10 and a communication circuit having a communication function with the server 30 may be separately provided.

The communication unit 202 performs wireless communication with the terminal 10 by a predetermined communication method under the control of the control unit 201. Furthermore, the communication unit 202 communicates with the server 30 by a predetermined communication method under the control of the control unit 201.

The server 30 includes a control unit 301, a communication unit 302, and a storage unit 303.

The control unit 301 includes a processor such as a CPU. The control unit 301 controls operation of each unit of the server 30.

The communication unit 302 is a communication circuit having a communication function with the receiving station 20. The communication unit 302 communicates with the receiving station 20 by a predetermined communication method under the control of the control unit 301.

The storage unit 303 is a storage apparatus such as a hard disk drive (HDD) or a semiconductor memory. The storage unit 303 stores programs and data under the control of the control unit 301. For example, the storage unit 303 stores data such as a learning data set used for generating a learned model.

The control unit 301 includes a learned model generation unit 311, a reception result list generation unit 312, a data collection unit 313, and a relearning unit 314.

The learned model generation unit 311 generates (creates) a learned model by performing training using the learning data set stored in the storage unit 303. As the learned model, a frame detector that receives a reception signal as an input and outputs a time at which a frame exists can be generated.

The reception result list generation unit 312 generates (creates) a reception result list for each combination of the receiving station 20 and the terminal 10 on the basis of the reception information transmitted from the receiving station 20. The reception information includes at least one of a reception signal from the terminal 10, a terminal ID of the terminal 10, a demodulation result in a single frame, a demodulation result in a synthesis frame, a frame transmission time, or a frame detection time.

The data collection unit 313 collects supervised data on the basis of the reception result list generated by the reception result list generation unit 312. For example, the supervised data is supervised data of a frame that has failed to be demodulated as a single frame, and is collected by using the deviation amount between the detection time and the transmission time of a frame that has been successfully demodulated as a single frame in a case where the deviation amount between the transmission time at the terminal 10 and the reception time at the receiving station 20 is constant between repeated frames. The data including the collected supervised data is stored in the storage unit 303.

The relearning unit 314 newly generates a learning data set by adding the supervised data collected by the data collection unit 313 to the learning data set stored in the storage unit 303. The relearning unit 314 relearns the generated learned model using the generated learning data set. Note that, since relearning can be regarded as part of learning, “relearning” described in the present specification may be replaced with “learning”.

Here, in general, in a case where individual optimization is automatically performed in each machine learning model, semi-supervised learning in which a large amount of unsupervised data not to be annotated is collected is suitable. The annotation is labeling the correct answer or answer with respect to the data input to the machine learning. However, if possible, the performance can be expected in the supervised learning in which the annotation is performed on all the learning data. In a wireless system that performs error detection, it is possible to determine whether or not a detection frame has been correctly demodulated after detection.

As a result, by performing the annotation in which the reception signal is used as the input data and the time when the frame exists is used as the teacher data, it is possible to automatically collect the supervised data and to relearn the learned model by the supervised learning. However, in the error detection, in a case where the data cannot be correctly received, the teacher data cannot be generated. In this case, there is a problem that it becomes impossible to collect supervised data, and it is difficult to improve performance by learning a signal that fails in reception or an interference pattern. Therefore, the present disclosure proposes a method of determining teacher data of a frame for a frame that fails to be demodulated as a single frame, and automatically performing effective collection of supervised data and relearning of a learned model.

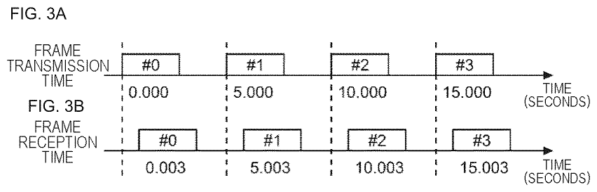

FIG. 3 is a diagram illustrating a deviation amount between the frame transmission time and the frame reception time. A of FIG. 3 illustrates the transmission time of the frame (DT frame) transmitted by the terminal 10 in time series. B of FIG. 3 illustrates the reception time of the frame (DT frame) received by the receiving station 20, that is, the time when the frame transmitted from the terminal 10 actually reaches the receiving station 20 in time series.

In FIG. 3, when four frames #0, #1, #2, and #3 transmitted from the terminal 10 are received by the receiving station 20, the relationship between the frame transmission time and the frame reception time is 0.000 (seconds) and 0.003 (seconds), 5.000 (seconds) and 5.003 (seconds), 10.000 (seconds) and 10.003 (seconds), 15.000 (seconds) and 15.003 (seconds), and the deviation amount is 0.003 (seconds) and is constant.

In the first embodiment, as illustrated in FIG. 3, a case is assumed where the deviation amount between the frame transmission time and the frame reception time is constant between repeated frames. The transmission time of the frame is defined by calculation, but the time when the frame (DT frame) actually reaches the receiving station 20 may be delayed due to various factors. For example, the factors include a propagation delay due to a distance between the transceivers or the like.

In the first embodiment, it is possible to efficiently collect supervised learning data and to relearn a learned model by creating teacher data of a frame that has failed to be demodulated as a single unit using a time difference (deviation amount) between a detection time of a frame that has been successfully demodulated as a single unit and a transmission time calculated from terminal ID information.

### <System Operation>

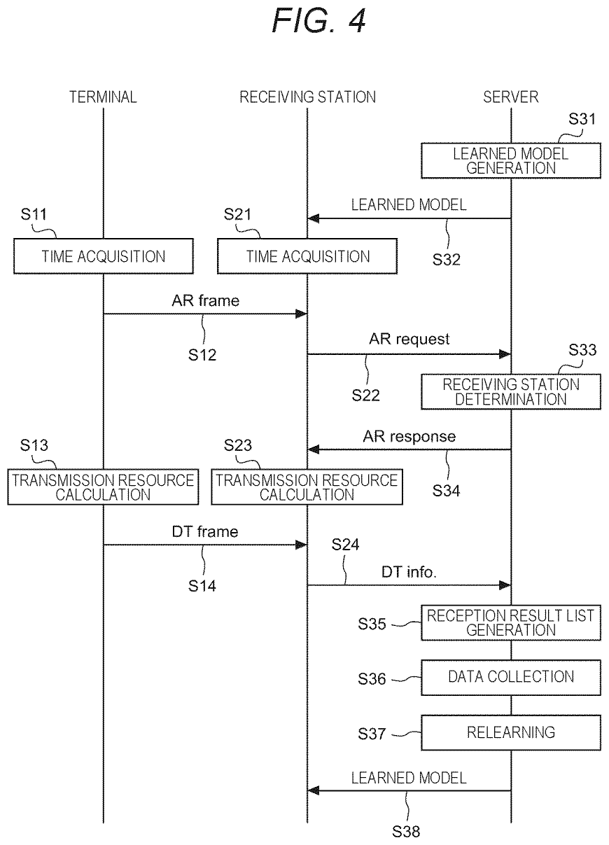

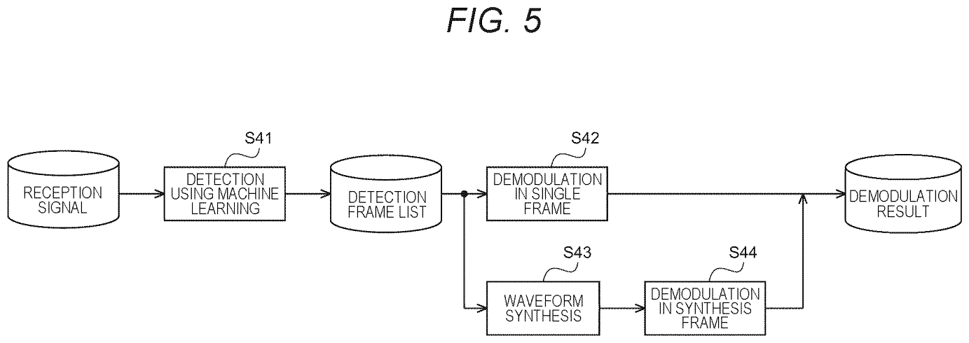

An operation of a system to which the present disclosure is applied will be described with reference to FIGS. 4 and 5. As a system to which the present disclosure is applied, a system that performs time synchronization as a whole is assumed. FIG. 4 is a diagram illustrating a sequence of the entire system. FIG. 5 is a diagram illustrating details of DT frame reception processing by the receiving station 20.

In FIG. 4, the processing in steps S11 to S14 is executed by the terminal 10, the processing in steps S21 to S24 is executed by the receiving station 20, and the processing in steps S31 to S38 is executed by the server 30. Although omitted for convenience of description, in practice, one or a plurality of receiving stations 20 is provided for one server 30, and one or a plurality of terminals 10 is provided for one receiving station 20.

In the server 30, the learned model generation unit 311 performs supervised learning using the learning data set and generates a learned model (S31). The server 30 transmits the generated learned model to the receiving station 20 (S32).

Here, a frame detector to which a machine learning method is applied can be generated. The frame detector uses a learned model trained by a learning data set. When the reception signal divided by a certain period is used as input data, the input size is fixed, and thus, a convolutional neural network (CNN) or the like can be used as the type of the machine learning model.

When the learned model is generated, a large amount of input data and teacher data are stored in the storage unit 303 in association with each other. The reception signal can be used as the input data, and the time at which the frame exists can be used as the teacher data.

The terminal 10 and the receiving station 20 acquire time information and perform time synchronization between the transceivers (S11 and S21). The time information can be acquired from a GPS receiver or the like. When the time information is acquired, the position information may be acquired at the same time. Other positioning systems may be used in addition to the GPS.

The terminal 10 periodically transmits an AR frame to the receiving station 20 (S12). The AR frame is a signal requesting the receiving station 20 to receive the DT frame. The AR frame includes a terminal ID, rough position information of the terminal, and a cyclic redundancy code (CRC). The CRC is used in the receiving station 20 on the reception side for determination of reception success.

The receiving station 20 performs AR frame reception processing and transmits the terminal ID and the rough position information included in the AR frame to the server 30 (S22). At this time, the receiving station 20 also transmits the receiving station ID. This processing is referred to as AR request. The information included in the AR request may include the information included in the received AR frame, a list of the number of received AR frames including the time when the AR frame has been received, and the position information of the receiving station itself.

In the server 30, the control unit 301 performs receiving station determination processing and determines which receiving station 20 receives the terminal ID transmitted in the AR request (S33). The server 30 transmits information including the terminal ID to be received to the receiving station 20 (S34). This processing is referred to as AR response.

The terminal 10 and the receiving station 20 calculate transmission resources (S13 and S23). The transmission time of the DT frame is determined by a method shared between the transceivers. For example, a pseudo random number generator using the terminal ID and the time information can generate a random number sequence and determine the transmission time.

The terminal 10 periodically transmits a DT frame to the receiving station 20 (S14). In order to improve the reception sensitivity, the signal of the DT frame can be repeatedly transmitted a plurality of times. In the description, a case where the number of repeated frames is 4 will be exemplified. The receiving station 20 performs DT frame reception processing of receiving a DT frame from the terminal 10. The terminal 10 transmitting the DT frame corresponds to the terminal ID included in the AR response from the server 30. Details of the DT frame reception processing are illustrated in FIG. 5.

As illustrated in FIG. 5, in the DT frame reception processing, a frame is detected from the reception signal (S41), demodulation processing according to the modulation scheme is performed (S42, or S43 and S44), and error detection using CRC is performed. Decoding processing such as a scrambling code or an error correction code may be performed according to a signal to be handled. Since the signal of the DT frame is repeatedly transmitted a plurality of times from the terminal 10, in addition to demodulation in a single frame (S42), the detected frame is subjected to waveform synthesis for the number of repeated frames and demodulated (S43 and S44). Even when demodulation fails in a single frame, there is a case where demodulation succeeds in a synthesized frame, and sensitivity can be improved by waveform synthesis.

In the process of detecting a frame from a reception signal (S41), a frame detector to which a machine learning method is applied is used. The frame detector is transmitted from the server 30. The frame detector inputs a reception signal from the terminal 10 to output the time at which the frame exists. Frame detection becomes possible by cutting out a signal corresponding to a frame time length from the time at which the frame exists in the reception signal.

Returning to FIG. 4, the receiving station 20 transmits reception information (DT Info.) to the server 30 (S24). For example, the received terminal ID, the demodulation result in the single frame, the demodulation result in the synthesis frame, the reception signal, the frame transmission time, and the frame detection time are transmitted as the reception information. In a case where the demodulation is successful, the receiving station 20 can transmit the sensor information from the terminal 10 to the server 30.

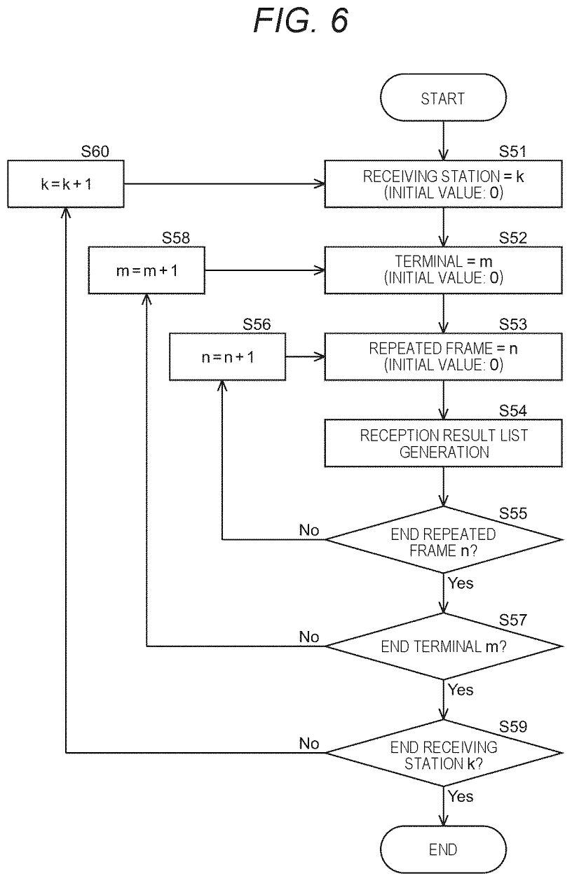

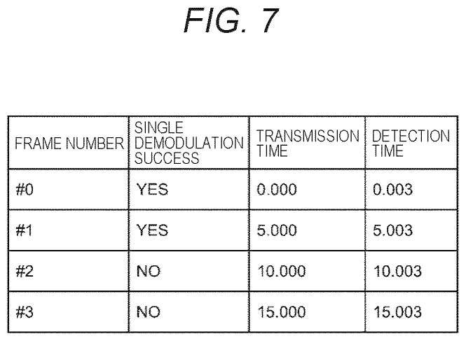

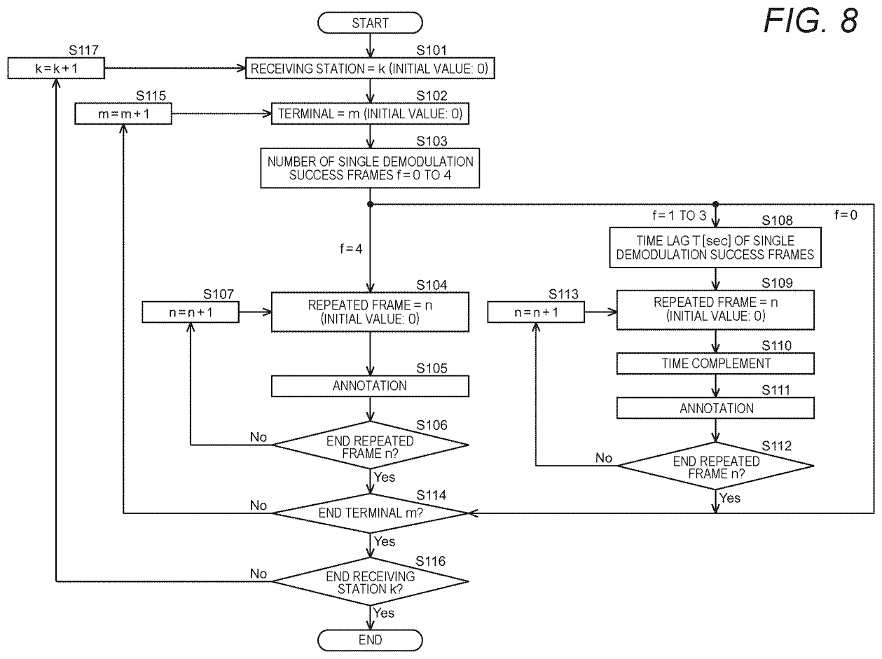

In the server 30, the reception result list generation unit 312 generates the reception result list on the basis of the reception information received from each receiving station 20 (S35). Details of the reception result list generation will be described later with reference to FIGS. 6 and 7. Furthermore, in the server 30, the data collection unit 313 collects data on the basis of the generated reception result list (S36). Details of the data collection will be described later with reference to FIG. 8.

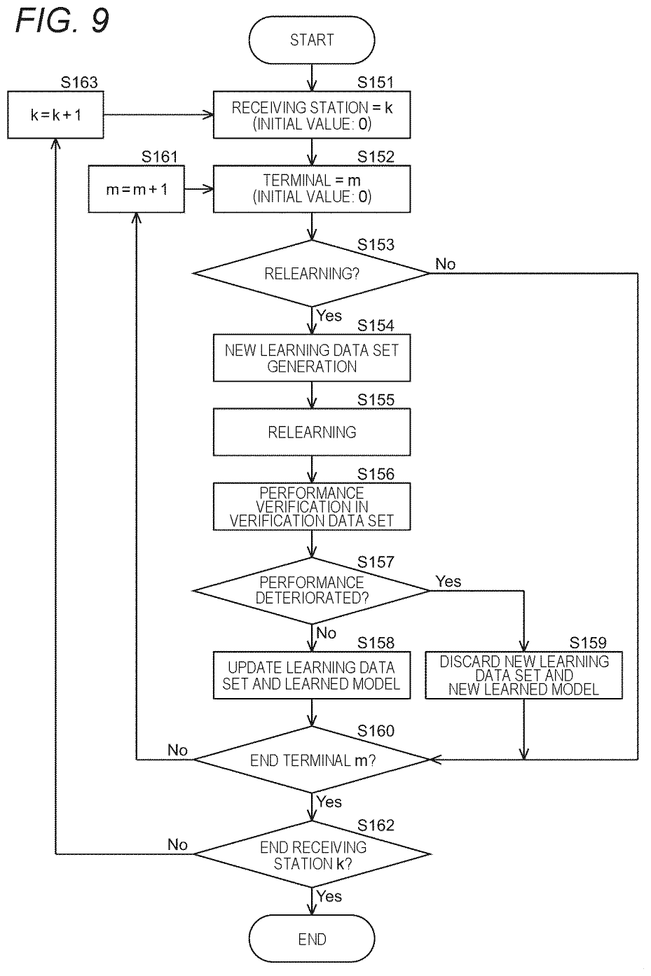

In the server 30, the relearning unit 314 relearns the learned model (frame detector) generated in the above-described S31 using the learning data set including the collected supervised data (S37). Details of the relearning will be described later with reference to FIG. 9. In a case where the learned model is updated by relearning, the server 30 transmits the learned model to each receiving station 20 (S38). According to the above procedure, the sensor information acquired by the terminal 10 can be collected by the server 30.

### <Generation of Reception Result List>

With reference to FIGS. 6 and 7, a method for generating a reception result list corresponding to the processing in step S35 in FIG. 4 will be described. The flowchart of FIG. 6 illustrates a flow of reception result list generation processing executed by the reception result list generation unit 312. FIG. 7 illustrates an example of the reception result list.

First, an initial value of the counter is set at a start position of each loop (S51 to S53). In step S51, k=0 is set as an initial value of the counter k of the receiving station loop that is the loop of the receiving station 20. In step S52, m=0 is set as an initial value of the counter m of the terminal loop which is the loop of the terminal 10. In step S53, n=0 is set as an initial value of the counter n of the frame loop which is the loop of repeated frames.

The receiving station loop is a loop repeated according to the number of receiving stations 20. The number of repetitions of the receiving station loop is counted by the counter k. The terminal loop is a loop repeated according to the number of terminals 10. The number of repetitions of the terminal loop is counted by the counter m. The frame loop is a loop repeated according to the number of repeated frames. The number of repetitions of the frame loop is counted by the counter n.

In step S54, a reception result list is generated. In step S55, it is checked whether all the repeated frames have been executed at the end position of the frame loop. In a case where (repeated frame n)<(repeated frame upper limit number−1) is satisfied in step S55, the processing proceeds to step S56. In step S56, 1 is added to the counter n of the frame loop. Then, the processing returns to step S53, and the above-described processing is repeated.

By repeating the frame loop in this manner, a reception result list in a combination of a certain receiving station 20 and the terminal 10 is generated. FIG. 7 is a diagram illustrating an example of a reception result list. The reception result list of FIG. 7 is generated in a case where the number of repeated frames is 4 and the frame transmission time and the frame reception time have the relationship as illustrated in FIG. 3.

In the reception result list of FIG. 7, the single frame demodulation result, the transmission time Calc_T (n), and the detection time Det_T (n) are put together for each frame identified by the frame number. The single frame demodulation result “YES” indicates that the single frame has been successfully demodulated, and “NO” indicates that the single frame has failed to be demodulated. The transmission time and the detection time correspond to the times A and B in FIG. 3.

In a case where (repeated frame n)=(repeated frame upper limit number−1) is satisfied in step S55, the processing proceeds to step S57. In step S57, it is checked whether all the terminals 10 have been executed at the end position of the terminal loop. In a case where (terminal m)<(terminal upper limit number−1) is satisfied in step S57, the processing proceeds to step S58, and 1 is added to the counter m in the terminal loop. Then, the processing returns to step S52, and the above-described processing is repeated.

On the other hand, in a case where (terminal m)=(terminal upper limit number−1) is satisfied in step S57, the processing proceeds to step S59. In step S59, it is checked whether all the receiving stations 20 have been executed at the end position of the receiving station loop. In a case where (receiving station k)<(receiving station upper limit number−1) is satisfied in step S59, the processing proceeds to step S60, and 1 is added to the counter k of the receiving station loop. Then, the processing returns to step S51, and the above-described processing is repeated. In a case where (receiving station k)=(receiving station upper limit number−1) is satisfied in step S59, a series of processing is terminated.

As described above, the reception result list generation processing is executed, whereby the reception result list in which the single frame demodulation result, the transmission time, and the detection time are collected is generated for each combination of the receiving station 20 and the terminal 10. For example, a reception result list as illustrated in FIG. 7 is generated for each combination of the receiving station 20 and the terminal 10.

### <Data Collection>

Next, a data collection method corresponding to the processing in step S36 in FIG. 4 will be described with reference to FIG. 8. The flowchart of FIG. 8 illustrates a flow of data collection processing executed by the data collection unit 313.

First, an initial value of the counter is set at a start position of each loop (S101 and S102). In step S101, k=0 is set as an initial value of the counter k in the receiving station loop. In step S102, m=0 is set as an initial value of the counter m of the terminal loop.

In step S103, it is checked how many single demodulation success frames are present in the repeated frames of the receiving station k and the terminal m in the reception result list. In step S103, the processing is branched according to the checked number of single demodulation success frames. In this example, since the case where the number of repeated frames is 4 is described, the number of single demodulation success frames f is one of 0 to 4.

In a case where (the number of single demodulation success frames)=(repeated frame upper limit number) is satisfied in step S103, that is, in a case where f=4 is satisfied, the processing proceeds to step S104. In step S104, n=0 is set as an initial value of the counter n at the start position of the frame loop.

In step S105, the annotation in which the reception signal is set as the input data and the detection time Det_T (n) is set as the teacher data is performed.

In step S106, it is checked whether all the repeated frames have been executed at the end position of the frame loop. In a case where (repeated frame n)<(repeated frame upper limit number−1) is satisfied in step S106, the processing proceeds to step S107, and 1 is added to the counter n of the frame loop. Then, the processing returns to step S104, and the above-described processing is repeated. On the other hand, in a case where (repeated frame n)=(repeated frame upper limit number−1) is satisfied in step S106, the processing proceeds to step S114.

In addition, in a case where (the number of single demodulation success frames)<(repeated frame upper limit number) and (the number of single demodulation success frames)>0 are satisfied in step S103, that is, in a case where f=1 to 3 is satisfied, the processing proceeds to step S108.

In step S108, the time lag T [sec] between the detection time Det_T (n) of the frame n that has been successfully demodulated as a single unit in the repeated frames and the transmission time Calc_T (n) calculated from the terminal ID information is calculated. That is, the time lag T is calculated by the following Equation (1).

$$T = Det\_T ( n ) - Calc\_T ( n ) \qquad ( 1 )$$

In step S109, n=0 is set as an initial value of the counter n at the start position of the frame loop.

In step S110, time complement is performed. That is, since the time lag T is constant between the repeated frames, the frame time Ans_T (n) is created as the teacher data by adding the time lag T to the transmission time Calc_T (n) of the frame. That is, the frame time Ans_T (n) is calculated by the following Equation (2).

$$Ans\_T ( n ) = Calc\_T ( n ) + T \qquad ( 2 )$$

In step S111, annotation is performed with the reception signal as input data and the frame time Ans_T (n) as teacher data.

In step S112, it is checked whether all the repeated frames have been executed at the end position of the frame loop. In a case where (repeated frame n)<(repeated frame upper limit number−1) is satisfied in step S112, the processing proceeds to step S113, and 1 is added to the counter n of the frame loop. Then, the processing returns to step S109, and the above-described processing is repeated. On the other hand, in a case where (repeated frame n)=(repeated frame upper limit number−1) is satisfied in step S112, the processing proceeds to step S114.

In addition, in a case where (the number of single demodulation success frames)=0 is satisfied in step S103, that is, in a case where f=0 is satisfied, the processing proceeds to step S114.

In step S114, it is checked whether all the terminals 10 have been executed at the end position of the terminal loop. In a case where (terminal m)<(terminal upper limit number−1) is satisfied in step S114, the processing proceeds to step S115, and 1 is added to the counter m in the terminal loop. Then, the processing returns to step S102, and the above-described processing is repeated. On the other hand, in a case where (terminal m)=(terminal upper limit number−1) is satisfied in step S114, the processing proceeds to step S116.

In step S116, it is checked whether all the receiving stations 20 have been executed at the end position of the receiving station loop. In a case where (receiving station k)< (receiving station upper limit number−1) is satisfied in step S116, the processing proceeds to step S117, and 1 is added to the counter k of the receiving station loop. Then, the processing returns to step S101, and the above-described processing is repeated. On the other hand, in a case where (receiving station k)=(receiving station upper limit number−1) is satisfied in step S116, the series of processing is terminated.

As described above, by executing the data collection processing, the data collection processing can be summarized as the following (A) to (C) according to the branch (f=0, f=4, or f=1 to 3) of the number of single demodulation success frames.

### (A) Number of Single Demodulation Success Frames=0

When the number of single demodulation success frames is 0, the annotation is not performed.

### (B) Number of Single Demodulation Success Frames=4

When the number of single demodulation success frames is 4, since the detection time Det_T (n) of all the frames is the correct frame time, the annotation in which the reception signal is set as the input data and the detection time Det_T (n) is set as the teacher data is performed. Four pieces of data can be collected.

### (C) Number of Single Demodulation Success Frames=1 to 3

When the number of single demodulation success frames is 1 to 3, the correct time of the frame is obtained from the detection time when the single demodulation is successful. Since the time lag T is constant between the repeated frames, by adding the time lag T to the transmission time Calc_T (n) of the frame, the frame time Ans_T (n)=Calc_T (n)+T is created as teacher data. The annotation is performed with the reception signal as input data and the frame time Ans_T (n) as teacher data. Four pieces of data can be collected.

### <Relearning>

Next, a relearning method corresponding to the processing in step S37 in FIG. 4 will be described with reference to FIG. 9. The flowchart of FIG. 9 illustrates a flow of relearning processing executed by the relearning unit 314.

First, an initial value of the counter is set at a start position of each loop (S151 and S152). In step S151, k=0 is set as an initial value of the counter k in the receiving station loop. In step S152, m=0 is set as an initial value of the counter m of the terminal loop.

In step S153, it is determined whether to execute relearning. For example, when a certain number of supervised data collected by the server 30 is accumulated in the storage unit 303, it is determined to execute relearning. The determination may be made based on not only the number of data but also the length of the data collection period, for example.

In a case where it is determined in step S153 that relearning is to be executed, the processing proceeds to step S154. In step S154, a new learning data set in which the supervised data collected by the server 30 is added to the existing learning data set is generated. In step S155, relearning of the existing learned model is executed using the new learning data set, and a new learned model is generated.

In step S156, the performance verification of the new learned model is performed using the verification data set. In step S157, the performance of the existing learned model is compared with the performance of the new learned model acquired in step S156, and it is determined whether the performance has deteriorated.

In a case where it is determined in step S157 that the performance of the new learned model is not deteriorated as compared with the performance of the existing learned model, the processing proceeds to step S158. In step S158, the existing learned model is updated to a new learned model. In addition, in step S158, the existing learning data set is updated to a new learning data set.

On the other hand, in a case where it is determined in step S157 that the performance of the new learned model has deteriorated as compared with the performance of the existing learned model, the processing proceeds to step S159. In step S159, the new learning data set and the new learned model are discarded.

When the processing of step S158 or S159 ends, the processing proceeds to step S160. Furthermore, in a case where it is determined in step S153 that relearning is not to be executed, steps S154 to S159 are skipped, and the processing proceeds to step 160.

In step S160, it is checked whether all the terminals 10 have been executed at the end position of the terminal loop. In a case where (terminal m)<(terminal upper limit number−1) is satisfied in step S160, the processing proceeds to step S161, and 1 is added to the counter m in the terminal loop. Then, the processing returns to step S152, and the above-described processing is repeated. On the other hand, in a case where (terminal m)=(terminal upper limit number−1) is satisfied in step S160, the processing proceeds to step S162.

In step S162, it is checked whether all the receiving stations 20 have been executed at the end position of the receiving station loop. In a case where (receiving station k)< (receiving station upper limit number−1) is satisfied in step S162, the processing proceeds to step S163, and 1 is added to the counter k of the receiving station loop. Then, the processing returns to step S151, and the above-described processing is repeated. On the other hand, in a case where (receiving station k)=(receiving station upper limit number−1) is satisfied in step S162, the series of processing is terminated.

By the above method, by using the detection time of a frame that has been successfully demodulated as a single unit, it is possible to create teacher data of a frame that has failed to be demodulated as a single unit among repeated frames, and effective construction of a reception model with good reception performance can be expected by supervised learning.

In addition, since it is expected that the tendency of interference varies due to a difference in use case and transmission frequency for each terminal ID, it is effective to sort effective learning data and unnecessary learning data for the current learned model by updating the learning data for each terminal ID and relearning the model. When relearning is performed without storing a certain number of collected data sets, there is a possibility that an effect does not appear in the verification data set and learning data is collected and updated while it is unclear whether the data is useful data or unnecessary data, and storing a certain number of data sets is effective for sorting learning data.

### Second Embodiment

In the first embodiment, one or more frames that are successfully demodulated as a single unit are required in the repeated frames, and the learning data cannot be collected in a case where all the frames fail to be demodulated as a single unit. Therefore, in the second embodiment, a method is proposed that enables efficient collection of learning data by creating teacher data using reception sensitivity in a case where all frames in repeated frames fail to perform demodulation as a single unit.

In the second embodiment, points different from the first embodiment will be described. Differences from the first embodiment are three points of reception information transmitted from the receiving station 20 to the server 30, reception result list generation, and data collection.

### <System Operation>

The system operation is the operation illustrated in the sequence of FIG. 4, but the operation of transmitting the reception information (DT Info) from the receiving station 20 to the server 30 is different in step S24 of FIG. 4. In the second embodiment, the reception sensitivity of each frame is added to the reception information (DT Info). As an index of the reception sensitivity, a radio field intensity received signal strength indicator (RSSI), an output value of a frame detector using machine learning, or the like can be used.

### <Generation of Reception Result List>

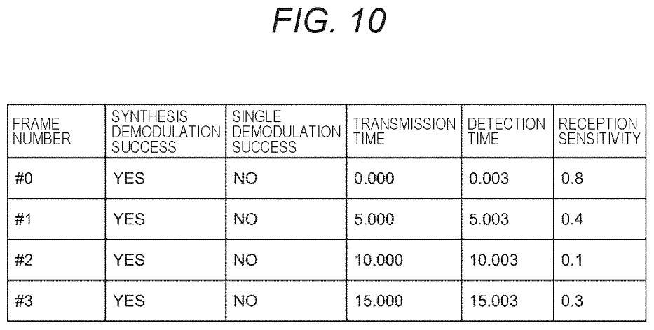

In step S35 of FIG. 4, the operation of generating the reception result list is different. Details of the processing of step S35 of FIG. 4 are illustrated in the flowchart of FIG. 6, but in the second embodiment, a reception result list as illustrated in FIG. 10 is generated for each combination of the receiving station 20 and the terminal 10 in step S54 of FIG. 6.

The reception result list in FIG. 10 is generated in a case where the number of repeated frames is 4 and the relationship between the frame transmission time and the frame reception time is as illustrated in FIG. 3. In the reception result list of FIG. 10, the frame synthesis demodulation result, the single frame demodulation result, the transmission time Calc_T (n), the detection time Det_T (n), and the reception sensitivity are put together for each frame identified by the frame number.

The frame synthesis demodulation result as “YES” indicates that the synthesis demodulation has succeeded, and is “NO” in a case where the synthesis demodulation has failed. In the example of FIG. 10, the frame synthesis demodulation results are all “YES”, indicating that synthesis demodulation has succeeded for all the frames. In addition, in the example of FIG. 10, the single frame demodulation results are all “NO”, indicating that the demodulation as a single unit has failed in all the frames. The transmission time and the detection time correspond to the times A and B in FIG. 3. In the example of FIG. 10, the reception sensitivities of the four frames #0, #1, #2, and #3 are 0.8, 0.4, 0.1, and 0.3, respectively.

### <Data Collection>

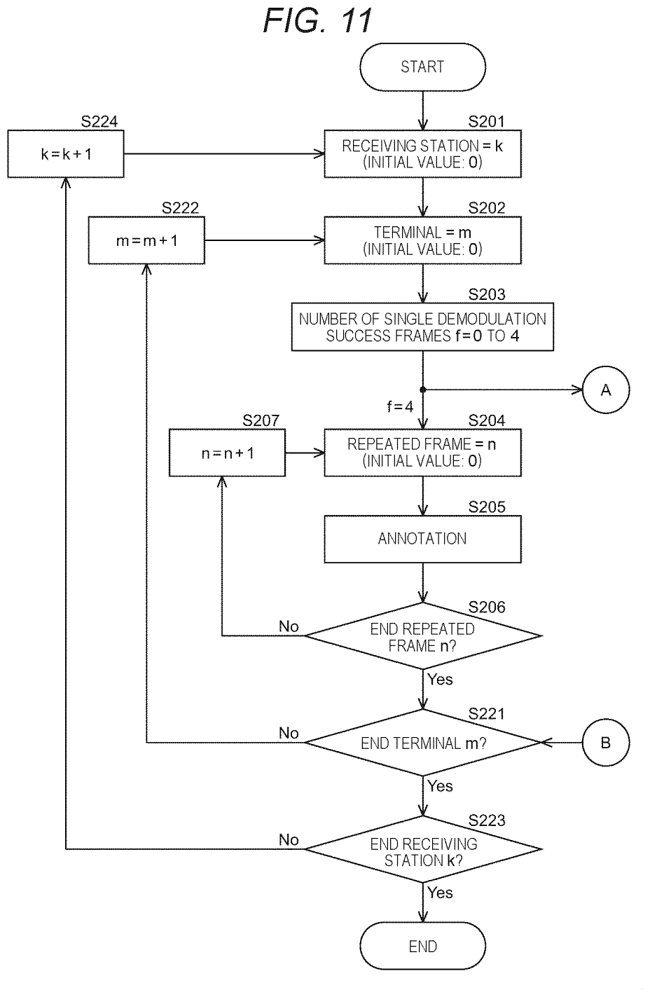

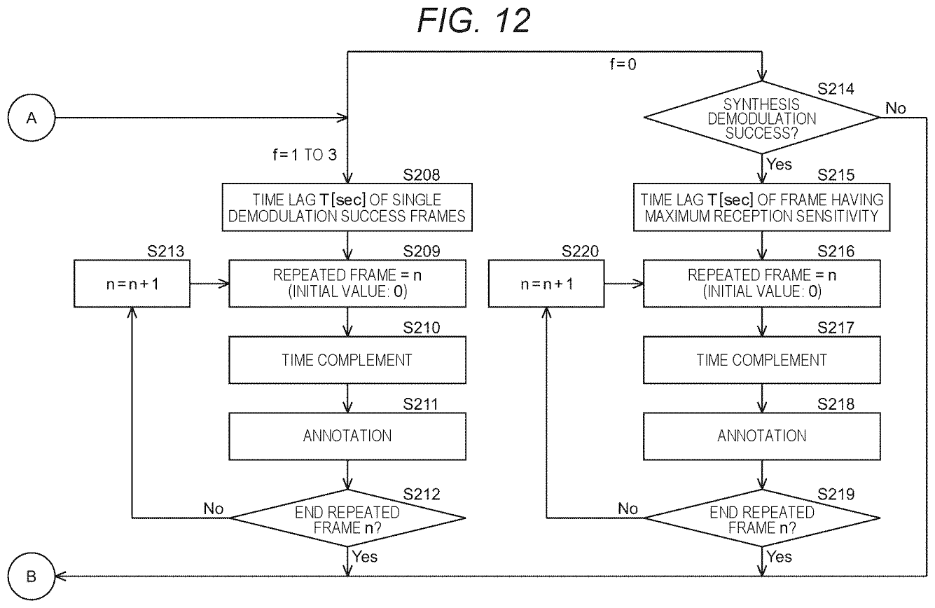

In step S36 of FIG. 4, the operation of collecting data is different. A flow of data collection processing in the second embodiment will be described with reference to flowcharts of FIGS. 11 and 12.

In steps S201 and S202, similarly to steps S101 and S102 in FIG. 8, k=0 and m=0 are respectively set as initial values of the counter k of the receiving station loop and the counter m of the terminal loop.

In step S203, it is checked how many single demodulation success frames are present in the repeated frames of the receiving station k and the terminal m in the reception result list. The processing is branched according to the number of single demodulation success frames obtained as a result of the confirmation. In this example, since the case where the number of repeated frames is 4 is described, the number of single demodulation success frames f is one of 0 to 4.

In a case where (the number of single demodulation success frames)=(repeated frame upper limit number) is satisfied in step S203 (in a case where f=4 is satisfied), the processing proceeds to step S204.

In steps S204 to S207, similarly to steps S104 to S107 in FIG. 8, the frame loop is repeated, and the annotation in which the reception signal is set as the input data and the detection time Det_T (n) is set as the teacher data is performed. When (repeated frame n)=(repeated frame upper limit number−1) is satisfied in step S206, the processing proceeds to step S221.

Furthermore, in a case where (the number of single demodulation success frames)<(repeated frame upper limit number) and (the number of single demodulation success frames)>0 are satisfied in step S203 (in a case where f=1 to 3 is satisfied), the processing proceeds to step S208 in FIG. 12.

In steps S208 to S213, similarly to steps S108 to S113 in FIG. 8, the frame loop is repeated after the time lag T of the frame n that has been successfully demodulated as a single unit is calculated. In the frame loop, by performing the time complement, after the frame time Ans_T (n) is created as the teacher data, the annotation in which the reception signal is used as the input data and the frame time Ans_T (n) is used as the teacher data is performed.

Here, the time lag T is calculated by the above-described Equation (1), and the frame time Ans_T (n) is calculated by the above-described Equation (2). When (repeated frame n)=(repeated frame upper limit number−1) is satisfied in step S212, the processing proceeds to step S221 in FIG. 11.

Furthermore, in a case where (the number of single demodulation success frames)=0 is satisfied in step S203 (in a case where f=0 is satisfied), the processing proceeds to step S214 in FIG. 12. In step S214, from the reception result list of the receiving station k and the terminal m, whether the synthesis demodulation succeeds in the repeated frames is checked.

In step S214, in a case where the synthesis demodulation is successful, the processing proceeds to step S215. In step S215, the time lag T between the detection time Det_T (n) and the transmission time Calc_T (n) calculated from the terminal ID information is calculated in the frame having the maximum reception sensitivity from the reception result list of the receiving station k and the terminal m. That is, the time lag T is calculated by the following Equation (3).

$$T = Det\_T ( n ) - Calc\_T ( n ) \qquad ( 3 )$$

In step S216, n=0 is set as an initial value of the counter n at the start position of the frame loop.

In step S217, time complement is performed. That is, since the time lag T is constant between the repeated frames, the frame time Ans_T (n) is created as teacher data by adding the time lag T to the transmission time Calc_T (n) of the frame. That is, the frame time Ans_T (n) is calculated by the following Equation (4).

$$Ans\_T ( n ) = Calc\_T ( n ) + T \qquad ( 4 )$$

In step S218, annotation is performed with the reception signal as input data and the frame time Ans_T (n) as teacher data.

In step S219, it is checked whether all the repeated frames have been executed at the end position of the frame loop. In a case where (repeated frame n)<(repeated frame upper limit number−1) is satisfied in step S219, the processing proceeds to step S220, and 1 is added to the counter n of the frame loop. Then, the processing returns to step S216, and the above-described processing is repeated. On the other hand, in a case where (repeated frame n)=(repeated frame upper limit number−1) is satisfied in step S219, the processing proceeds to step S221 in FIG. 11. In addition, in a case where the synthesis demodulation is not successful in step S214, the processing proceeds to step S221 in FIG. 11.

In steps S221 to S224, similarly to steps S114 to S117 in FIG. 8, the terminal loop is repeated while incrementing the counter m until all the terminals 10 are executed and the end position of the terminal loop is reached. Further, after the terminal loop ends, the receiving station loop is repeated while incrementing the counter k. Then, the receiving station loop and the terminal loop are repeated, and when all the receiving stations 20 are executed and the end position of the receiving station loop is reached, the series of processing is ended.

By executing the data collection processing illustrated in FIGS. 11 and 12, the data collection processing can be summarized as the following (A) to (C) according to the branch (f=0, f=4, or f=1 to 3) of the number of single demodulation success frames.

### (A) Number of Single Demodulation Success Frames=0

When the number of single demodulation success frames is 0, a time lag T=Det_T (n)−Calc_T (n) between the detection time Det_T (n) of the frame having the highest reception sensitivity in the repeated frames and the transmission time Calc_T (n) calculated from the terminal ID information is calculated. A frame time Ans_T (n)=Calc_T (n)+T is created as teacher data by adding the time lag T to the transmission time Calc_T (n) of the frame. The annotation is performed with the reception signal as input data and the frame time Ans_T (n) as teacher data. Four pieces of data can be collected.

### (B) Number of Single Demodulation Success Frames=4

When the number of single demodulation success frames is 4, the case is similar to the first embodiment.

### (C) Number of Single Demodulation Success Frames=1 to 3

When the number of single demodulation success frames is 1 to 3, the case is similar to the first embodiment.

By the above method, by using the detection time of the frame having the highest reception sensitivity, it is possible to create teacher data even in a case where all the repeated frames fail to be demodulated as a single unit, and it is possible to expect effective construction of a reception model with good reception performance by supervised learning. Even in a case where all the repeated frames fail to be demodulated as a single unit, two or more frames are successfully detected in a case where demodulation of the synthesized frames is successful. By assuming that the frame detection time with high reception sensitivity is correct, it is possible to create teacher data of a frame that has failed to be demodulated as a single unit.

In addition, since it is expected that the tendency of interference varies due to a difference in use case and transmission frequency for each terminal ID, it is effective to sort effective learning data and unnecessary learning data for the current learned model by updating the learning data for each terminal ID and relearning the model. When relearning is performed without storing a certain number of collected data sets, there is a possibility that an effect does not appear in the verification data set and learning data is collected and updated while it is unclear whether the data is useful data or unnecessary data, and storing a certain number of data sets is effective for sorting learning data.

### Third Embodiment

In the second embodiment, there is a case where correct teacher data cannot be created in a case where a frame of which detection has failed due to a strong input interference signal or the like has the highest reception sensitivity among repeated frames. Therefore, in the third embodiment, a method is proposed in which it is possible to collect learning data even if strong input interference or the like exists by using reception information in another receiving station 20.

In the third embodiment, points different from the second embodiment will be described. Differences from the second embodiment are two points of reception result list generation and data collection.

### <Generation of Reception Result List>

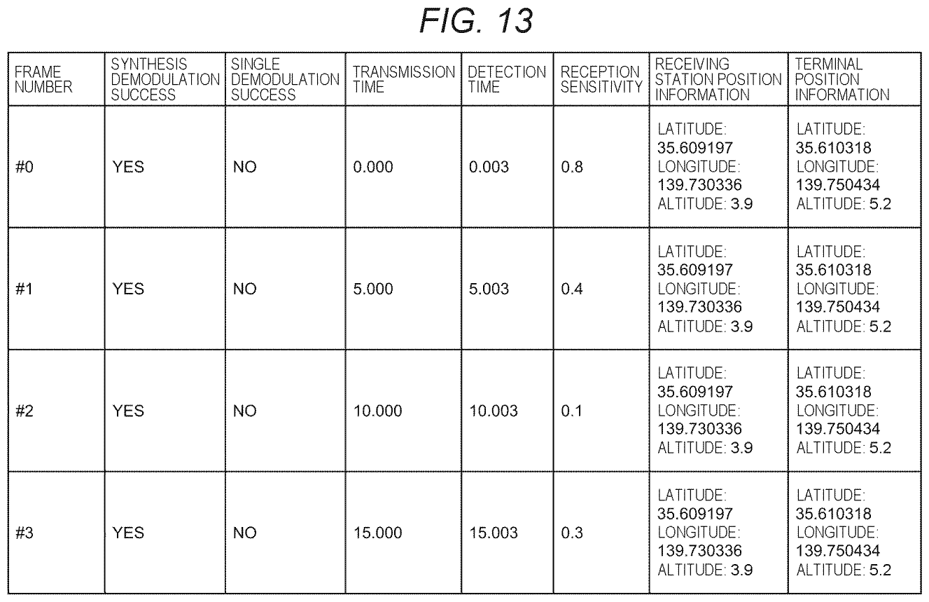

In step S35 of FIG. 4, the operation of generating the reception result list is different. Details of the processing of step S35 of FIG. 4 are illustrated in the flowchart of FIG. 6, but in the third embodiment, in step S54 of FIG. 6, a reception result list as illustrated in FIG. 13 is generated for each combination of the receiving station 20 and the terminal 10.

The reception result list in FIG. 13 is generated in a case where the number of repeated frames is 4 and the relationship between the frame transmission time and the frame reception time is as illustrated in FIG. 3. In the reception result list of FIG. 13, the frame synthesis demodulation result, the single frame demodulation result, the transmission time Calc_T (n), the detection time Det_T (n), the reception sensitivity, the receiving station position information, and the terminal position information are put together for each frame identified by the frame number.

In the example of FIG. 10, the latitude, longitude, and altitude of the receiving station 20 are included as the receiving station position information. Furthermore, the terminal position information includes the latitude, longitude, and altitude of the terminal 10. For example, the position information can be acquired when the terminal 10 and the receiving station 20 perform time synchronization, and can be transmitted from the receiving station 20 to the server 30 as sensor information or included in the reception information (DT Info). Alternatively, in a case where the positions of the terminal 10 and the receiving station 20 are known, the position information acquired on the server 30 side may be used.

### <Data Collection>

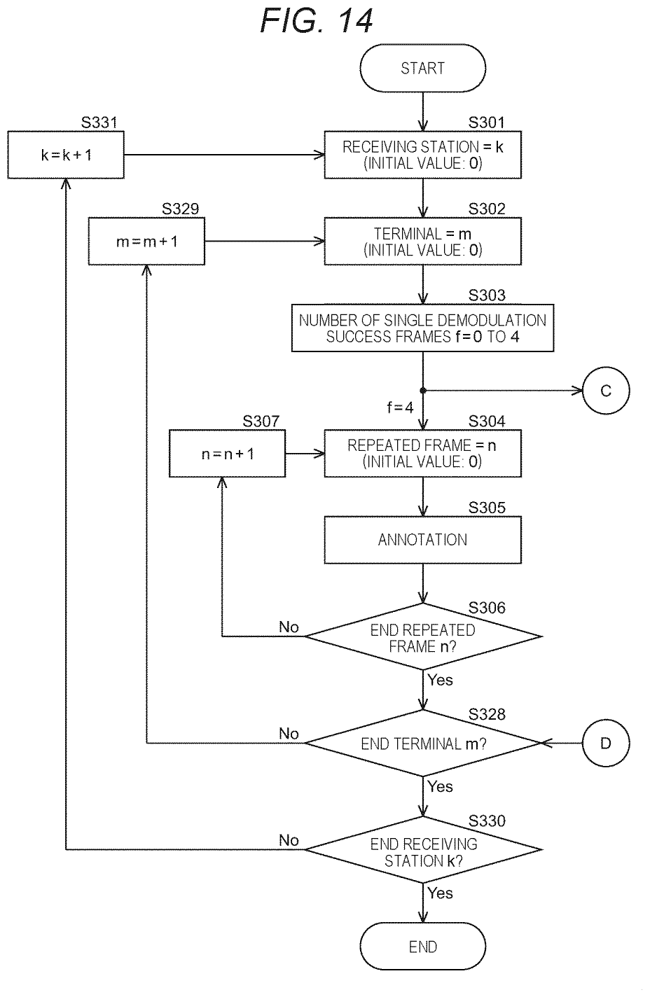

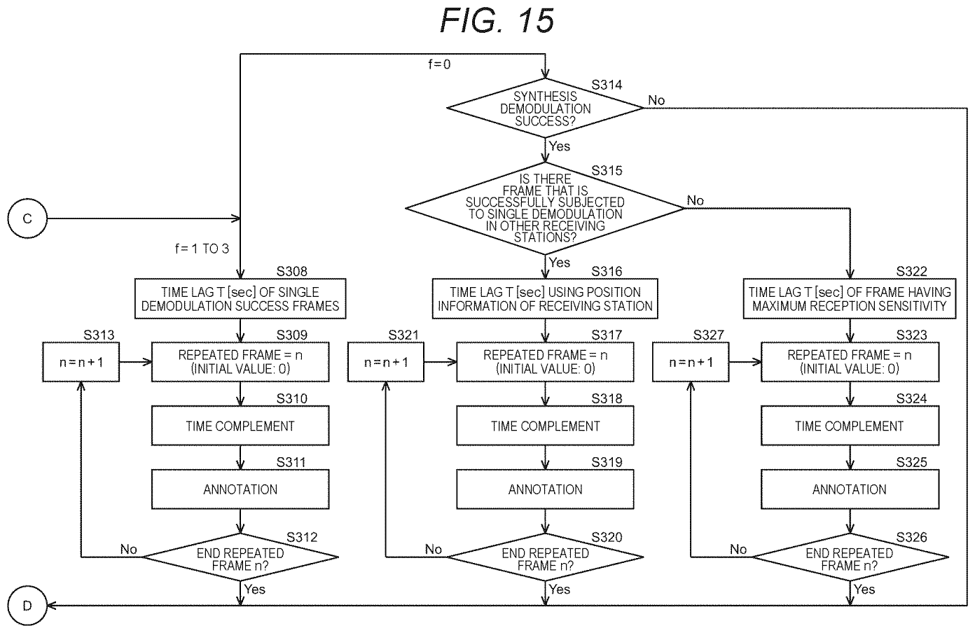

In step S36 of FIG. 4, the operation of collecting data is different. A flow of data collection processing in the third embodiment will be described with reference to flowcharts of FIGS. 14 and 15.

In steps S301 and S302, similarly to steps S201 and S202 in FIG. 11, k=0 and m=0 are respectively set as initial values of the counter k of the receiving station loop and the counter m of the terminal loop.

In step S303, similarly to step S203 in FIG. 11, it is checked how many single demodulation success frames are present in the repeated frames of the receiving station k and the terminal m in the reception result list, and the processing is branched according to the number of single demodulation success frames. In this example, since the case where the number of repeated frames is 4 is described, the number of single demodulation success frames f is one of 0 to 4.

In a case where (the number of single demodulation success frames)=(repeated frame upper limit number) is satisfied in step S303 (in a case where f=4 is satisfied), the processing proceeds to step S304.

In steps S304 to S307, similarly to steps S204 to S207 in FIG. 11, the frame loop is repeated, and the annotation in which the reception signal is set as the input data and the detection time Det_T (n) is set as the teacher data is performed. When (repeated frame n)=(repeated frame upper limit number−1) is satisfied in step S306, the processing proceeds to step S328.

Furthermore, in a case where (the number of single demodulation success frames)<(repeated frame upper limit number) and (the number of single demodulation success frames)>0 are satisfied in step S303 (in a case where f=1 to 3 is satisfied), the processing proceeds to step S308 in FIG. 15.

In steps S308 to S313, similarly to steps S208 to 213 in FIG. 12, the frame loop is repeated after the time lag T of the frame n that has been successfully demodulated as a single unit is calculated. In the frame loop, by performing the time complement, after the frame time Ans_T (n) is created as the teacher data, the annotation in which the reception signal is used as the input data and the frame time Ans_T (n) is used as the teacher data is performed. Here, the time lag T is calculated by the above-described Equation (1), and the frame time Ans_T (n) is calculated by the above-described Equation (2). When (repeated frame n)=(repeated frame upper limit number−1) is satisfied in step S312, the processing proceeds to step S328 in FIG. 14.

Furthermore, in a case where (the number of single demodulation success frames)=0 is satisfied in step S303 (in a case where f=0 is satisfied), the processing proceeds to step S314 in FIG. 15. In step S314, from the reception result list of the receiving station k and the terminal m, whether the synthesis demodulation succeeds in the repeated frames is checked.

In step S314, in a case where the synthesis demodulation is successful, the processing proceeds to step S315. In step S315, from the reception result lists of the terminals m of all the receiving stations, it is checked whether there is a frame that is successfully subjected to the single demodulation in the receiving stations 20 (the other receiving stations 20) other than the receiving station k. In step S315, in a case where there is a frame that is successfully subjected to the single demodulation in other receiving stations 20, the processing proceeds to step S316.

In step S316, a straight line distance Dk [km] of (the terminal m, the receiving station k, and other receiving stations) and a straight line distance Do [km] of (the terminal m and other receiving stations) are calculated from the position information of (the terminal m and the receiving station k). As a result, the distance difference D [km] can be calculated by the following Equation (5). In addition, assuming that the speed of light is c [km/s], the time difference Diff T [sec] between the receiving station k and the other receiving station 20 receiving the signal from the terminal m can be calculated by the following Equation (6).

$$D = Dk - Do \qquad ( 5 )$$

$$Diff\_T = D / c \qquad ( 6 )$$

The time difference Diff T is added to the detection time Det_T_o (n) [sec] of the frame n in the other receiving station 20 that has been successfully demodulated as a single unit, thereby calculating the frame time Ans_T (n) [sec] serving as the teacher data in the receiving station k that has failed to be demodulated as a single unit. That is, the frame time Ans_T (n) is calculated by the following Equation (7).

$$Ans\_T ( n ) = Det\_T \_o ( n ) + Diff\_T \qquad ( 7 )$$

Then, the transmission time Calc_T (n) [sec] calculated from the terminal ID and the time lag T [sec] of the teacher data are calculated by the following Equation (8).

$$T = Ans\_T ( n ) - Calc\_T ( n ) \qquad ( 8 )$$

In step S317, n=0 is set as an initial value of the counter n at the frame loop start position.

In step S318, time complement is performed. That is, since the time lag T is constant between the repeated frames, the frame time Ans_T (n) is created as teacher data by adding the time lag T to the transmission time Calc_T (n) of the frame. That is, the frame time Ans_T (n) is calculated by the following Equation (9).

$$Ans\_T ( n ) = Calc\_T ( n ) + T \qquad ( 9 )$$

In step S319, annotation is performed with the reception signal as input data and the frame time Ans_T (n) as teacher data.

In step S320, it is checked whether all the repeated frames have been executed at the end position of the frame loop. In a case where (repeated frame n)<(repeated frame upper limit number−1) is satisfied, the processing proceeds to step S321, and 1 is added to the counter n of the frame loop. Then, the processing returns to step S317, and the above-described processing is repeated. On the other hand, in a case where (repeated frame n)=(repeated frame upper limit number−1) is satisfied, the processing proceeds to step S328 in FIG. 14.

On the other hand, in step S315, in a case where there is no frame that is successfully subjected to the single demodulation in the other receiving stations 20, the processing proceeds to step S322. In steps S322 to S327, similarly to steps S215 to S220 in FIG. 12, the frame loop is repeated after the time lag T of the frame having the maximum reception sensitivity is calculated. In the frame loop, after the frame time Ans_T (n) is created as the teacher data, the annotation in which the reception signal is used as the input data and the frame time Ans_T (n) is used as the teacher data is performed.

Here, the time lag T is calculated by the above-described Equation (3), and the frame time Ans_T (n) is calculated by the above-described Equation (4). When (repeated frame n)=(repeated frame upper limit number−1) is satisfied in step S326, the processing proceeds to step S328 in FIG. 14. In addition, in a case where the synthesis demodulation is not successful in step S314, the processing proceeds to step S328 in FIG. 14.

In steps S328 to S331, similarly to steps S221 to S224 in FIG. 11, the terminal loop is repeated while incrementing the counter m until all the terminals 10 are executed and the end position of the terminal loop is reached. Further, after the terminal loop ends, the receiving station loop is repeated while incrementing the counter k. Then, the receiving station loop and the terminal loop are repeated, and when all the receiving stations 20 are executed and the end position of the receiving station loop is reached, the series of processing is ended.

By executing the data collection processing illustrated in FIGS. 14 and 15, the data collection processing can be summarized as the following (A) to (C) according to the branch (f=0, f=4, or f=1 to 3) of the number of single demodulation success frames.

### (A) Number of Single Demodulation Success Frames=0

When the number of single demodulation success frames is 0, the case is divided into two cases (I) and (II).

(I) In a case where there is another receiving station 20 in which the number of single demodulation success frames of the same repeated frames is 1 or more, the teacher data is created using the position information of the receiving station k and the other receiving station 20. From the position information of (the terminal m, the receiving station k, and other receiving stations), a straight line distance Dk [km] of (the terminal m and the receiving station k) and a straight line distance Do [km] of (the terminal m and other receiving stations) are calculated. The distance difference D [km]=Dk-Do is calculated. Assuming that the speed of light is c [km/s], a time difference Diff T=D/c [sec] between the receiving station k and the other receiving station 20 receiving the signal from the terminal m is calculated. By adding the time difference Diff T to the detection time Det_T_o (n) [s] of the frame n in the other receiving station 20 that has been successfully demodulated as a single unit, the frame time Ans_T (n)=Det_T_o (n)+Diff T [sec] serving as the teacher data in the receiving station k that has failed to be demodulated as a single unit is calculated. The transmission time Calc_T (n) [sec] calculated from the terminal ID and the time lag T=Ans_T (n)−Calc_T (n) of the teacher data are calculated. In the receiving station k, by adding the time lag T to the transmission time Calc_T (n) calculated from the terminal ID, teacher data Ans_T (n) in the receiving station k is created. The annotation is performed with the reception signal as input data and the frame time Ans_T (n) as teacher data. Four pieces of data can be collected.

(II) In a case where there is no other receiving station 20 in which the number of single demodulation success frames of the same repeated frames is 1 or more, teacher data is created using the reception sensitivity similarly to the second embodiment. Four pieces of data can be collected.

### (B) Number of Single Demodulation Success Frames=4

When the number of single demodulation success frames is 4, the case is similar to the first embodiment.

### (C) Number of Single Demodulation Success Frames=1 to 3

When the number of single demodulation success frames is 1 to 3, the case is similar to the first embodiment.

By the above method, by using the detection time of the frame in the other receiving station 20, it is possible to create teacher data even in a case where all the repeated frames fail to be demodulated as a single unit, and it is possible to expect effective construction of a reception model with good reception performance by supervised learning. Since the positions of the terminal 10 on the transmission side and each receiving station 20 are known, the reception time can be calculated from the route difference.

In addition, since it is expected that the tendency of interference varies due to a difference in use case and transmission frequency for each terminal ID, it is effective to sort effective learning data and unnecessary learning data for the current learned model by updating the learning data for each terminal ID and relearning the model. When relearning is performed without storing a certain number of collected data sets, there is a possibility that an effect does not appear in the verification data set and learning data is collected and updated while it is unclear whether the data is useful data or unnecessary data, and storing a certain number of data sets is effective for sorting learning data.

### Fourth Embodiment

In the first to third embodiments, it is assumed that the deviation amount between the transmission time calculated from the terminal ID information and the time in a case where the frame actually reaches the receiving station is constant between the repeated frames, and in a case where the deviation is not constant, there is a possibility that improvement in reception performance by relearning with the collected learning data cannot be expected. Therefore, in the fourth embodiment, by performing linear regression on the assumption that the deviation amount between the reception time of a frame that has been successfully demodulated as a single unit in the repeated frames and the transmission time calculated from the terminal ID information changes linearly as illustrated in FIG. 16, the reception time of a frame that has failed to be demodulated as a single unit is estimated, and learning data is collected.

FIG. 16 illustrates, in time series, a case where the deviation amount of the timing at which the frame (DT frame) transmitted from the terminal 10 actually reaches the receiving station 20 is in a proportional relationship. In FIG. 16, when four frames #0, #1, #2, and #3 transmitted from the terminal 10 are received by the receiving station 20, the relationship between the frame transmission time and the frame reception time is 0.000 (seconds) and 0.002 (seconds), 5.000 (seconds) and 5.004 (seconds), 10.000 (seconds) and 10.006 (seconds), 15.000 (seconds) and 15.008 (seconds), and the deviation amount increases at a constant rate, such as 0.002 (seconds), 0.004 (seconds), 0.006 (seconds), and 0.008 (seconds).

In the fourth embodiment, points different from the first embodiment will be described. Differences from the first embodiment are two points of reception result list generation and data collection.

### <Generation of Reception Result List>

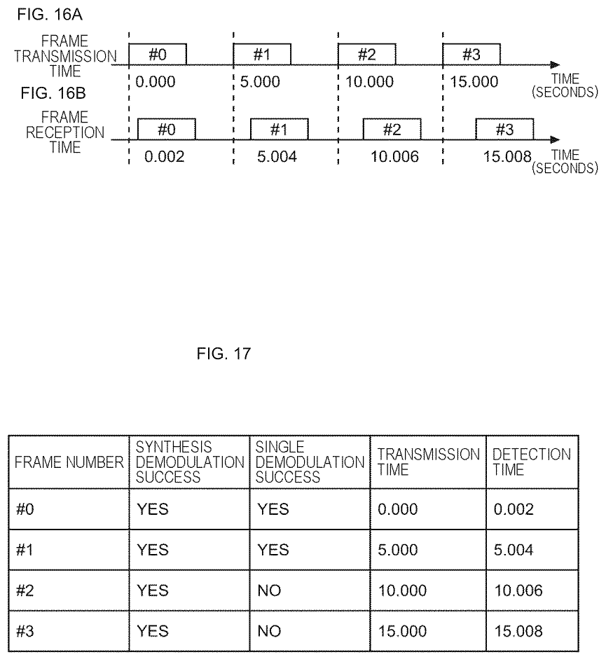

In step S35 of FIG. 4, the operation of generating the reception result list is different. Details of the processing of step S35 of FIG. 4 are illustrated in the flowchart of FIG. 6, but in the fourth embodiment, in step S54 of FIG. 6, a reception result list as illustrated in FIG. 17 is generated for each combination of the receiving station 20 and the terminal 10.

The reception result list in FIG. 17 is generated in a case where the number of repeated frames is 4 and the relationship between the frame transmission time and the frame reception time is as illustrated in FIG. 16. In the reception result list of FIG. 17, the frame synthesis demodulation result, the single frame demodulation result, the transmission time Calc_T (n), and the detection time Det_T (n) are put together for each frame identified by the frame number.

### <Data Collection>

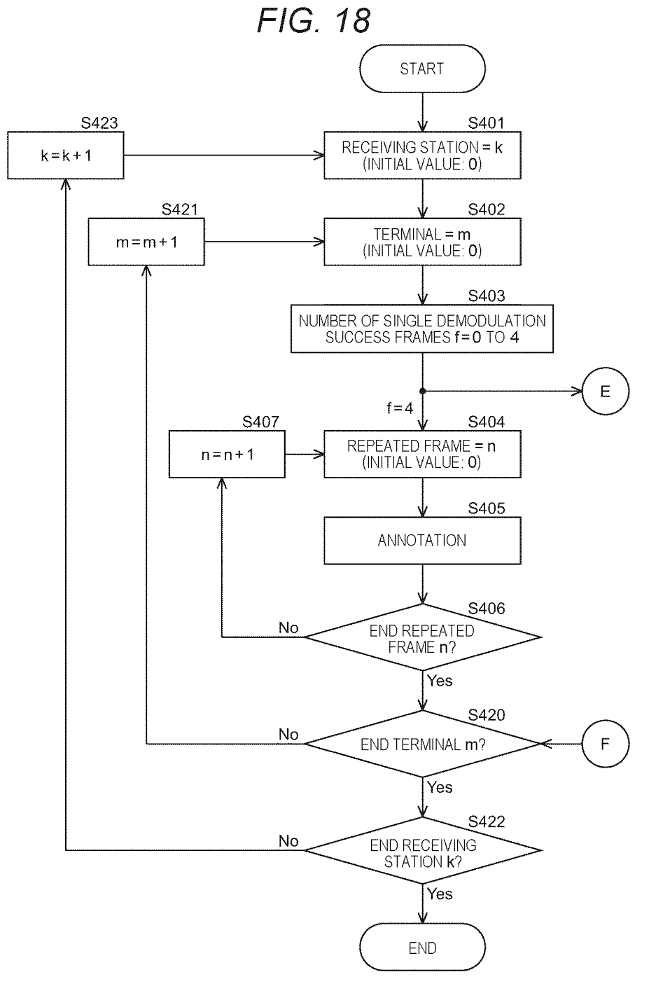

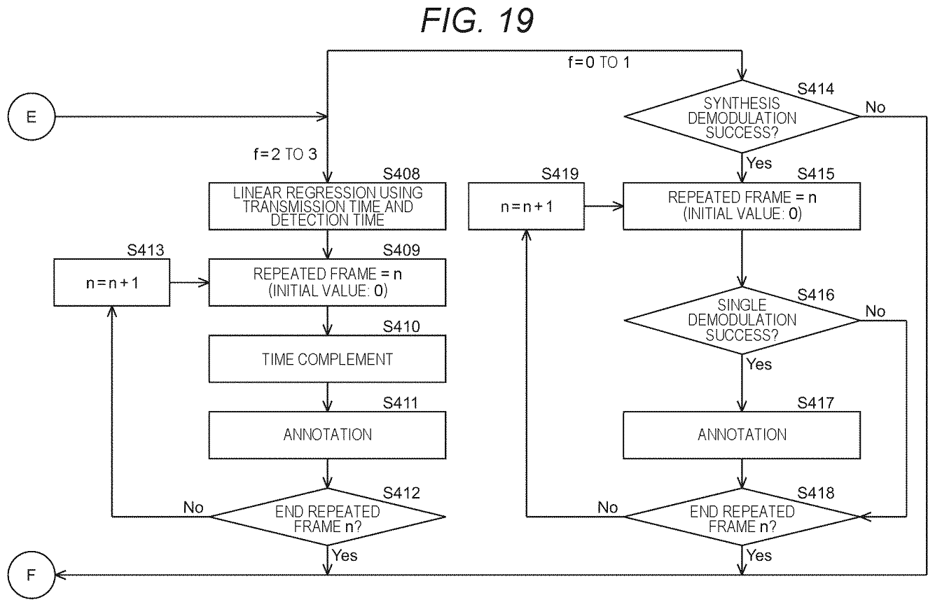

In step S36 of FIG. 4, the operation of collecting data is different. A flow of data collection processing in the fourth embodiment will be described with reference to flowcharts of FIGS. 18 and 19.

In steps S401 and S402, similarly to steps S101 and S102 in FIG. 8, k=0 and m=0 are respectively set as initial values of the counter k of the receiving station loop and the counter m of the terminal loop.

In step S403, it is checked how many single demodulation success frames are present in the repeated frames of the receiving station k and the terminal m in the reception result list. The processing is branched according to the number of single demodulation success frames obtained as a result of the confirmation. In this example, since the case where the number of repeated frames is 4 is described, the number of single demodulation success frames f is one of 0 to 4.

In a case where (the number of single demodulation success frames)=(repeated frame upper limit number) is satisfied in step S403 (in a case where f=4 is satisfied), the processing proceeds to step S404.

In steps S404 to S407, similarly to steps S104 to S107 in FIG. 8, the frame loop is repeated, and the annotation in which the reception signal is set as the input data and the detection time Det_T (n) is set as the teacher data is performed. When (repeated frame n)=(repeated frame upper limit number−1) is satisfied in step S406, the processing proceeds to step S420.

Furthermore, in a case where (the number of single demodulation success frames)<(repeated frame upper limit number) and (the number of single demodulation success frames)>1 are satisfied in step S403 (in a case where f=2 to 3 is satisfied), the processing proceeds to step S408 in FIG. 19.

In step S408, the relational expression between the transmission time and the detection time is obtained by linear regression in the frame in which the single demodulation succeeds among the repeated frames. For example, as illustrated in FIG. 17, in a case where single demodulation succeeds in frame #0 and frame #1, linear regression is performed using Det_T (0), Det_T (1), Calc_T (0), and Calc_T (1) to obtain values of a and b in the following Equation (10). Note that, in this example, a case where two frames of the frame #0 and the frame #1 are used has been described, but two or more frames that have succeeded in single demodulation can be used.

$$Det\_T ( n ) = a * Calc\_T ( n ) + b \qquad ( 10 )$$

In step S409, n=0 is set as an initial value of the counter n at the start position of the frame loop.

In step S410, time complement is performed. That is, the frame time Ans_T (n) is created as the teacher data using Equation (10) obtained in step S408. Specifically, Ans_T (n)=a*Calc_T (n)+b.

In step S411, annotation is performed with the reception signal as input data and the frame time Ans_T (n) as teacher data.

In step S412, it is checked whether all the repeated frames have been executed at the end position of the frame loop. In a case where (repeated frame n)<(repeated frame upper limit number−1) is satisfied in step S412, the processing proceeds to step S413, and 1 is added to the counter n of the frame loop. Then, the processing returns to step S409, and the above-described processing is repeated. On the other hand, in a case where (repeated frame n)=(repeated frame upper limit number−1) is satisfied in step S412, the processing proceeds to step S420 in FIG. 18.

In addition, in a case where (the number of single demodulation success frames)≤1 is satisfied in step S403 (in a case where f=0 to 1 is satisfied), the processing proceeds to step S414 in FIG. 19.

In step S414, from the reception result list of the receiving station k and the terminal m, whether the synthesis demodulation succeeds in the repeated frames is checked. In step S414, in a case where the synthesis demodulation is successful, the processing proceeds to step S415. In step S415, n=0 is set as an initial value of the counter n at the start position of the frame loop.

In step S416, from the reception result list of the receiving station k and the terminal m, whether the single demodulation of the frame n has succeeded is checked. In step S416, in a case where the single demodulation is successful, the processing proceeds to step S417. In step S417, the annotation in which the reception signal is set as the input data and the detection time Det_T (n) is set as the teacher data is performed.

When the processing of step S417 ends, the processing proceeds to step S418. In addition, in a case where the single demodulation is not successful in step S416, step S417 is skipped, and the processing proceeds to step S418.

In step S418, it is checked whether all the repeated frames have been executed at the end position of the frame loop. In a case where (repeated frame n)<(repeated frame upper limit number−1) is satisfied in step S418, the processing proceeds to step S419, and 1 is added to the counter n of the frame loop. Then, the processing returns to step S415, and the above-described processing is repeated. On the other hand, in a case where (repeated frame n)=(repeated frame upper limit number−1) is satisfied in step S418, the processing proceeds to step S420 in FIG. 18. In addition, in a case where the synthesis demodulation is not successful in step S414, the processing proceeds to step S420 in FIG. 18.

In steps S420 to S423, similarly to steps S114 to S117 in FIG. 8, the terminal loop is repeated while incrementing the counter m until all the terminals 10 are executed and the end position of the terminal loop is reached. Further, after the terminal loop ends, the receiving station loop is repeated while incrementing the counter k. Then, the receiving station loop and the terminal loop are repeated, and when all the receiving stations 20 are executed and the end position of the receiving station loop is reached, the series of processing is ended.

By executing the data collection processing illustrated in FIGS. 18 and 19, the data collection processing can be summarized as the following (A) to (C) according to the branch (f=0 to 1, f=4, or f=2 to 3) of the number of single demodulation success frames.

### (A) Number of Single Demodulation Success Frames=0 to 1

When the number of single demodulation success frames is 0 to 1, the annotation having the reception signal as the input data and the detection time Det_T (n) as the teacher data is performed in the frame that has been successfully demodulated as a single unit, and the annotation is not performed in the frame that has failed to be demodulated as a single unit.

### (B) Number of Single Demodulation Success Frames=4

When the number of single demodulation success frames is 4, the case is similar to the first embodiment.

### (C) Number of Single Demodulation Success Frames=2 to 3

When the number of single demodulation success frames is 2 to 3, a relational expression between the transmission time and the detection time is obtained by linear regression in the frame in which the single demodulation succeeds, and the detection time of the frame in which the single demodulation fails is estimated. Assuming a case where the single demodulation succeeds in the frame #0 and the frame #1, linear regression is performed using Det_T (0), Det_T (1), Calc_T (0), and Calc_T (1) to obtain a and b of Det_T (n)=a*Calc_T (n)+b in the above Equation (10). The frame time Ans_T (n)=a*Calc_T (n)+b is created using this Equation (10). The annotation is performed with the reception signal as the input data and the frame time Ans_T (n) as the teacher data. Four pieces of data can be collected.

By the above method, by using a plurality of detection times of a frame that has been successfully demodulated as a single unit, it is possible to create teacher data even in a case where the deviation amount between the timing to be received calculated from the terminal ID information and the timing at which the frame actually reaches the receiving station is not constant, and effective construction of a reception model with good reception performance can be expected by supervised learning.

In addition, since it is expected that the tendency of interference varies due to a difference in use case and transmission frequency for each terminal ID, it is effective to sort effective learning data and unnecessary learning data for the current learned model by updating the learning data for each terminal ID and relearning the model. When relearning is performed without storing a certain number of collected data sets, there is a possibility that an effect does not appear in the verification data set and learning data is collected and updated while it is unclear whether the data is useful data or unnecessary data, and storing a certain number of data sets is effective for sorting learning data.

### Fifth Embodiment

In the fourth embodiment, two or more frames that are successfully demodulated as a single unit are required in the repeated frames, and in a case where the number of frames that are successfully demodulated as a single unit is one or less, the learning data cannot be collected. Therefore, in the fifth embodiment, there is proposed a method capable of collecting learning data by creating teacher data by using reception sensitivity even in a case where the deviation amount between the timing to be received calculated from terminal ID information and the timing at which the frame actually reaches the receiving station 20 is different between repeated frames and in a case where the number of frames that are successfully demodulated as a single unit is one or less.

In the fifth embodiment, points different from the fourth embodiment will be described. Differences from the fourth embodiment are three points of reception information transmitted from the receiving station 20 to the server 30, reception result list generation, and data collection.

### <System Operation>

The system operation is the operation illustrated in the sequence of FIG. 4, but the operation of transmitting the reception information (DT Info) from the receiving station 20 to the server 30 is different in step S24 of FIG. 4. That is, in the fifth embodiment, the reception sensitivity of each frame is added to the reception information (DT Info). As an index of the reception sensitivity, a radio field intensity RSSI, an output value of a frame detector using machine learning, or the like can be used.

### <Generation of Reception Result List>

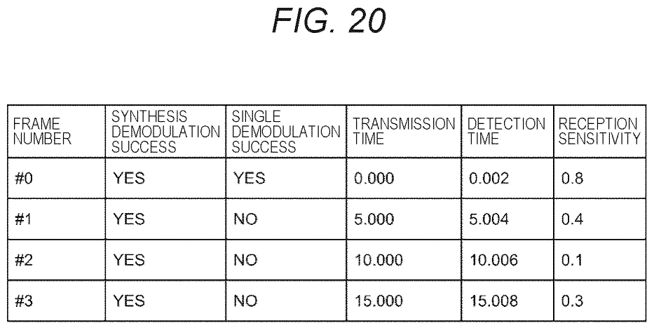

In step S35 of FIG. 4, the operation of generating the reception result list is different. Details of the processing of step S35 of FIG. 4 are illustrated in the flowchart of FIG. 6, but in the fifth embodiment, a reception result list as illustrated in FIG. 20 is generated for each combination of the receiving station 20 and the terminal 10 in step S54 of FIG. 6.

The reception result list in FIG. 20 is generated in a case where the number of repeated frames is 4 and the relationship between the frame transmission time and the frame reception time is as illustrated in FIG. 16. In the reception result list of FIG. 20, the frame synthesis demodulation result, the single frame demodulation result, the transmission time Calc_T (n), the detection time Det_T (n), and the reception sensitivity are put together for each frame identified by the frame number.

### <Data Collection>

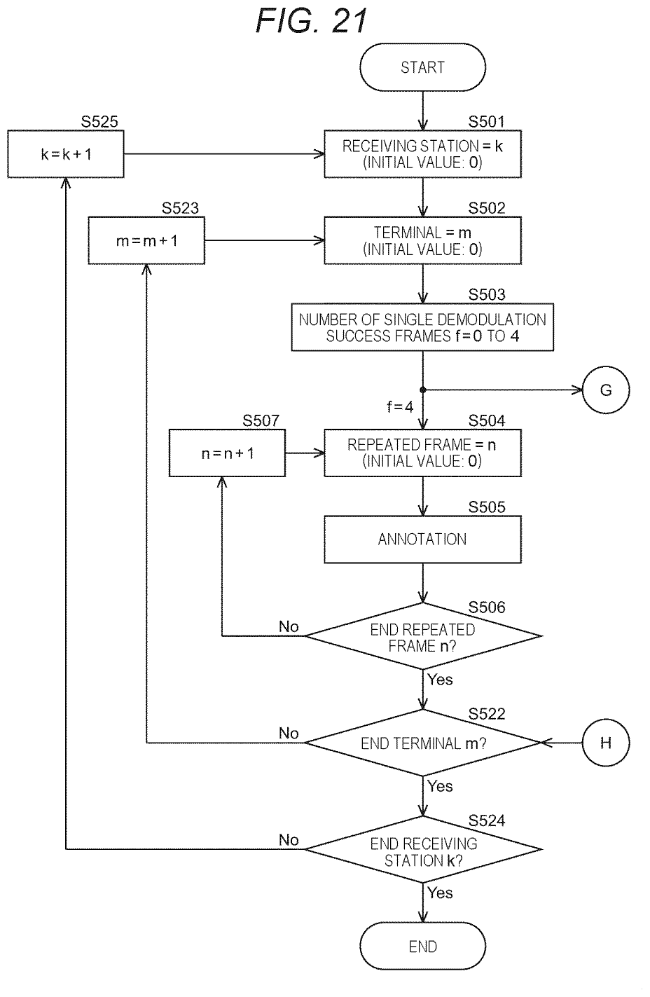

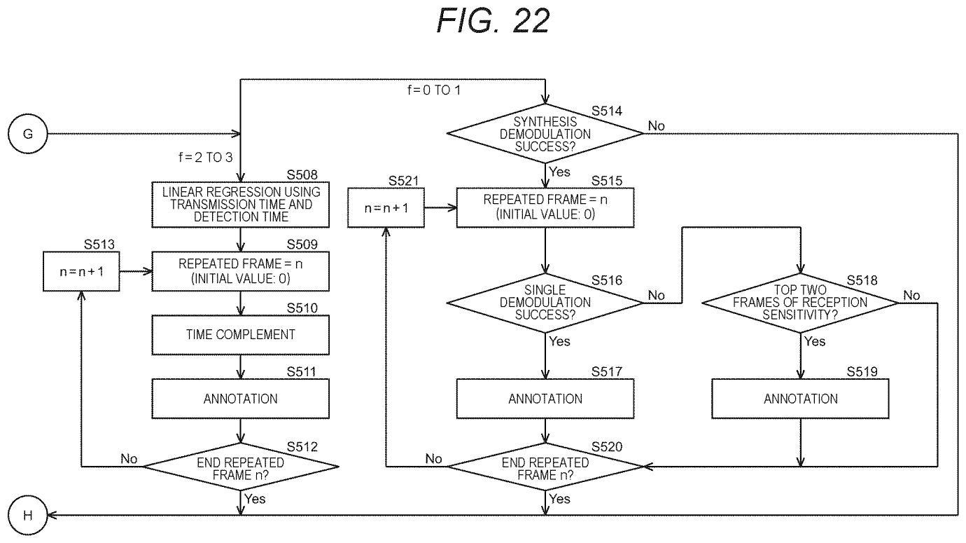

In step S36 of FIG. 4, the operation of collecting data is different. A flow of data collection processing in the fifth embodiment will be described with reference to flowcharts of FIGS. 21 and 22.

In steps S501 and S502, similarly to steps S401 and S402 in FIG. 18, k=0 and m=0 are respectively set as initial values of the counter k of the receiving station loop and the counter m of the terminal loop.

In step S503, it is checked how many single demodulation success frames are present in the repeated frames of the receiving station k and the terminal m in the reception result list. The processing is branched according to the number of single demodulation success frames obtained as a result of the confirmation. In this example, since the case where the number of repeated frames is 4 is described, the number of single demodulation success frames f is one of 0 to 4.

In a case where (the number of single demodulation success frames)=(repeated frame upper limit number) is satisfied in step S503 (in a case where f=4 is satisfied), the processing proceeds to step S504.

In steps S504 to S507, similarly to steps S404 to S407 in FIG. 18, the frame loop is repeated, and the annotation in which the reception signal is set as the input data and the detection time Det_T (n) is set as the teacher data is performed. When (repeated frame n)=(repeated frame upper limit number−1) is satisfied in step S506, the processing proceeds to step S522.

In addition, in a case where (the number of single demodulation success frames)<(repeated frame upper limit number) and (the number of single demodulation success frames)>1 are satisfied in step S503 (in a case where f=2 to 3 is satisfied), the processing proceeds to step S508 in FIG. 22.

In steps S508 to S513, similarly to steps S408 to S413 in FIG. 19, the relational expression between the transmission time and the detection time is obtained by linear regression in the frame in which the single demodulation succeeds, and then the frame loop is repeated. In the frame loop, by performing the time complement, after the frame time Ans_T (n) is created as the teacher data, the annotation in which the reception signal is used as the input data and the frame time Ans_T (n) is used as the teacher data is performed. Here, since the values of a and b in the above described Equation (10) are obtained by performing linear regression, the frame time Ans_T (n) can be created as teacher data by using this Equation (10). In a case where (repeated frame n)=(repeated frame upper limit number−1) in step S512, the processing proceeds to step S522 in FIG. 21.

In addition, in a case where (the number of single demodulation success frames)≤1 is satisfied in step S503 (in a case where f=0 to 1 is satisfied), the processing proceeds to step S514 in FIG. 22.

In step S514, from the reception result list of the receiving station k and the terminal m, whether the synthesis demodulation succeeds in the repeated frames is checked. In step S514, in a case where the synthesis demodulation is successful, the processing proceeds to step S515. In step S515, n=0 is set as an initial value of the counter n at the start position of the frame loop.

In step S516, from the reception result list of the receiving station k and the terminal m, whether the single demodulation of the frame n has succeeded is checked. In step S516, in a case where the single demodulation is successful, the processing proceeds to step S517. In step S517, the annotation in which the reception signal is set as the input data and the detection time Det_T (n) is set as the teacher data is performed. When the processing of step S517 ends, the processing proceeds to step S520.

On the other hand, in a case where the single demodulation has not succeeded in step S516, the processing proceeds to step S518. In step S518, from the reception result list of the receiving station k and the terminal m, it is checked whether the reception sensitivity of the frame n is included in the top two frames of the reception sensitivity among the four repeated frames.

In step S518, in a case where the reception sensitivity of the frame n is included in the top two frames, the processing proceeds to step S519. In step S519, the annotation in which the reception signal is set as the input data and the detection time Det_T (n) is set as the teacher data is performed. When the processing of step S519 ends, the processing proceeds to step S520. In addition, in step S518, in a case where the reception sensitivity of the frame n is not included in the top two frames, step S519 is skipped, and the processing proceeds to step S520.

In step S520, it is checked whether all the repeated frames have been executed at the end position of the frame loop. In a case where (repeated frame n)<(repeated frame upper limit number−1) is satisfied in step S520, the processing proceeds to step S521, and 1 is added to the counter n of the frame loop. Then, the processing returns to step S515, and the above-described processing is repeated. On the other hand, in a case where (repeated frame n)=(repeated frame upper limit number−1) is satisfied in step S520, the processing proceeds to step S522 in FIG. 21. In addition, in a case where the synthesis demodulation is not successful in step S514, the processing proceeds to step S522 in FIG. 21.

In steps S522 to S525, similarly to steps S420 to S423 in FIG. 18, the terminal loop is repeated while incrementing the counter m until all the terminals 10 are executed and the end position of the terminal loop is reached. Further, after the terminal loop ends, the receiving station loop is repeated while incrementing the counter k. Then, the receiving station loop and the terminal loop are repeated, and when all the receiving stations 20 are executed and the end position of the receiving station loop is reached, the series of processing is ended.

By executing the data collection processing illustrated in FIGS. 21 and 22, the data collection processing can be summarized as the following (A) to (C) according to the branch (f=0 to 1, f=4, or f=2 to 3) of the number of single demodulation success frames.

### (A) Number of Single Demodulation Success Frames=0 to 1

When the number of single demodulation success frames is 0 to 1, in the frame that has been successfully demodulated as a single unit and the frame in which the demodulation as a single unit fails but which is the top two frames with high reception sensitivity in the repeated frames, the annotation is performed with the reception signal as the input data and the detection time Det_T (n) as the teacher data, and the annotation is not performed in the other frames. Two pieces of data can be collected.

### (B) Number of Single Demodulation Success Frames=4

When the number of single demodulation success frames is 4, the case is similar to the first embodiment.

### (C) Number of Single Demodulation Success Frames=2 to 3

When the number of single demodulation success frames is 2 to 3, the case is similar to the fourth embodiment.

By the above method, it is possible to create teacher data of the top two frames with high reception sensitivity, and it is possible to expect effective construction of a reception model with good reception performance by supervised learning. In a case where demodulation of the synthesized frame is successful, detection of two or more frames is successful. By assuming that the frame detection time with high reception sensitivity is correct, it is possible to create teacher data of two frames that have failed to be demodulated as a single unit.

In addition, since it is expected that the tendency of interference varies due to a difference in use case and transmission frequency for each terminal ID, it is effective to sort effective learning data and unnecessary learning data for the current learned model by updating the learning data for each terminal ID and relearning the model. When relearning is performed without storing a certain number of collected data sets, there is a possibility that an effect does not appear in the verification data set and learning data is collected and updated while it is unclear whether the data is useful data or unnecessary data, and storing a certain number of data sets is effective for sorting learning data.

### Sixth Embodiment

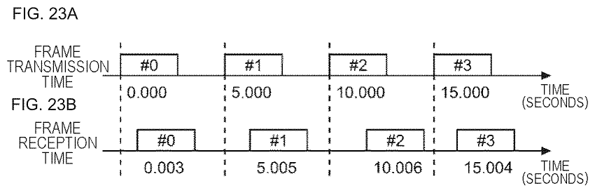

In the fourth and fifth embodiments, there is a problem that learning data cannot be collected in a case where the deviation amount between repeated transmission frames is not linear, or in a case where the reception sensitivity of a frame that has failed to be detected due to a strong input interference signal or the like is high in repeated frames. Therefore, in the sixth embodiment, a method is proposed in which by using reception information in another receiving station 20, learning data can be collected even in a case where the deviation amount between repeated transmission frames is not linear as illustrated in FIG. 23 or in a case where strong input interference or the like exists.

FIG. 23 illustrates, in time series, a case where the deviation amount of the timing at which the frame (DT frame) transmitted from the terminal 10 actually reaches the receiving station 20 cannot be approximated. In FIG. 23, when the four frames #0, #1, #2, and #3 transmitted from the terminal 10 are received by the receiving station 20, the relationship between the frame transmission time and the frame reception time is 0.000 (seconds) and 0.003 (seconds), 5.000 (seconds) and 5.005 (seconds), 10.000 (seconds) and 10.006 (seconds), 15.000 (seconds) and 15.004 (seconds), and the deviation amounts are not in a constant relationship such as 0.003 (seconds), 0.005 (seconds), 0.006 (seconds), and 0.004 (seconds).

In the sixth embodiment, points different from the first embodiment will be described. Differences from the first embodiment are two points of reception result list generation and data collection.

### <Generation of Reception Result List>

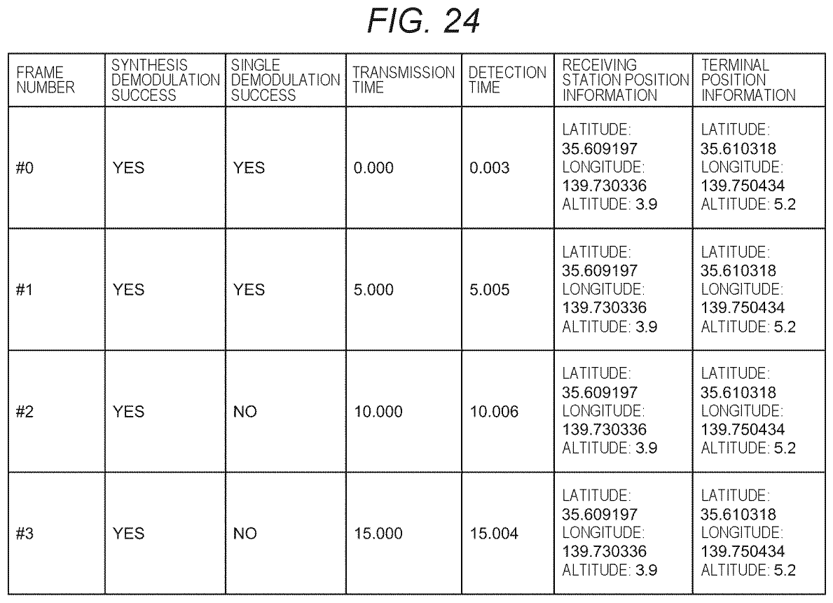

In step S35 of FIG. 4, the operation of generating the reception result list is different. Details of the processing of step S35 of FIG. 4 are illustrated in the flowchart of FIG. 6, but in the sixth embodiment, in step S54 of FIG. 6, a reception result list as illustrated in FIG. 24 is generated for each combination of the receiving station 20 and the terminal 10.

The reception result list in FIG. 24 is generated in a case where the number of repeated frames is 4 and the relationship between the frame transmission time and the frame reception time is as illustrated in FIG. 23. In the reception result list of FIG. 24, the frame synthesis demodulation result, the single frame demodulation result, the transmission time Calc_T (n), the detection time Det_T (n), the receiving station position information, and the terminal position information are put together for each frame identified by the frame number.

### <Data Collection>

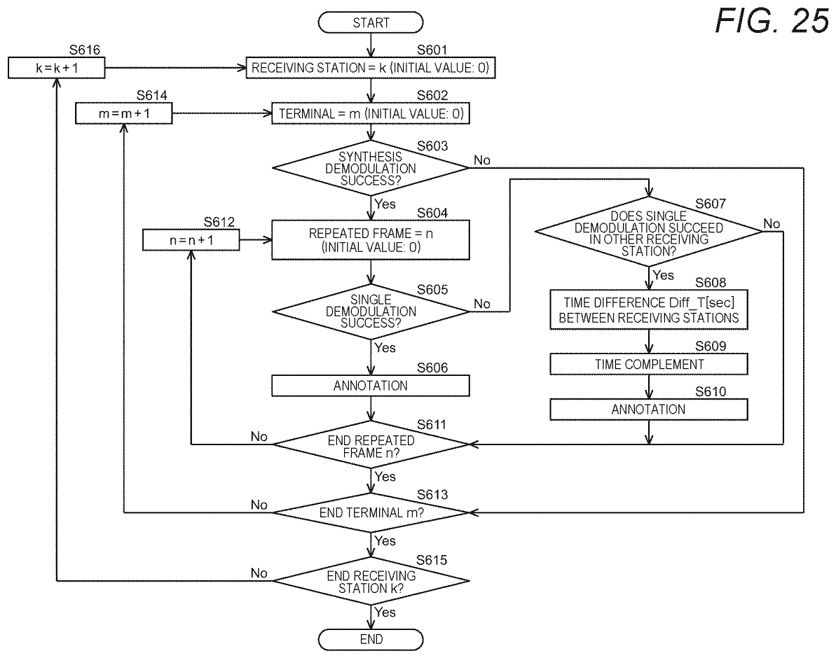

In step S36 of FIG. 4, the operation of collecting data is different. A flow of data collection processing in the sixth embodiment will be described with reference to a flowchart in FIG. 25.

In steps S601 and S602, similarly to steps S101 and S102 in FIG. 8, k=0 and m=0 are respectively set as initial values of the counter k of the receiving station loop and the counter m of the terminal loop.

In step S603, from the reception result list of the receiving station k and the terminal m, whether the synthesis demodulation succeeds in the repeated frames is checked. In step S603, in a case where the synthesis demodulation is successful, the processing proceeds to step S604. In step S604, n=0 is set as an initial value of the counter n at the start position of the frame loop.

In step S605, from the reception result list of the receiving station k and the terminal m, whether the single demodulation succeeds in the frame n is checked. In step S605, in a case where the single demodulation succeeds in the frame n, the processing proceeds to step S606. In step S606, the annotation in which the reception signal is set as the input data and the detection time Det_T (n) is set as the teacher data is performed. When the processing of step S606 ends, the processing proceeds to step S611.

On the other hand, in step S605, in a case where the single demodulation has not succeeded in the frame n, the processing proceeds to step S607. In step S607, from the reception result lists of the terminals m of all the receiving stations, it is checked whether there is a receiving station 20 that succeeds in single demodulation of the frame n other than the receiving station k. In step S607, in a case where the single demodulation of the frame n succeeds in the other receiving station 20, the processing proceeds to step S608.

In step S608, a straight line distance Dk [km] of (the terminal m, the receiving station k, and other receiving stations) and a straight line distance Do [km] of (the terminal m and other receiving stations) are calculated from the position information of (the terminal m and the receiving station k). As a result, the distance difference D [km] can be calculated by the following Equation (11). In addition, assuming that the speed of light is c [km/s], a time difference Diff T [sec] between the receiving station k and the other receiving station 20 receiving the signal from the terminal m can be calculated by the following Equation (12).

$$D = Dk - Do \qquad ( 11 )$$

$$Diff\_T = D / c \qquad ( 12 )$$

In step S609, time complement is performed. That is, by adding the time difference Diff T between the receiving stations to the detection time Det_T_o (n) [s] of the frame n in the other receiving station 20 that has been successfully demodulated as a single unit, the frame time Ans_T (n) [sec] serving as the teacher data in the receiving station k that has failed to be demodulated as a single unit is calculated. That is, the frame time Ans_T (n) is calculated by the following Equation (13).

$$Ans\_T ( n ) = Det\_T \_o ( n ) + Diff\_T [ sec ] \qquad ( 13 )$$

In step S610, annotation is performed with the reception signal as input data and the frame time Ans_T (n) as teacher data. When the processing of step S610 ends, the processing proceeds to step S611. Furthermore, in step S607, in a case where the single demodulation of the frame n is not successful in the other receiving station 20, steps S608 to S610 are skipped, and the processing proceeds to step S611.

In step S611, it is checked whether all the repeated frames have been executed at the end position of the frame loop. In a case where (repeated frame n)<(repeated frame upper limit number−1) is satisfied in step S611, the processing proceeds to step 612, and 1 is added to the counter n of the frame loop. Then, the processing returns to step S604, and the above-described processing is repeated. On the other hand, in a case where (repeated frame n)=(repeated frame upper limit number−1) is satisfied in step 611, the processing proceeds to step S613. In addition, in a case where the synthesis demodulation is not successful in step S603, the processing proceeds to step S613.

In steps S613 to S616, similarly to steps S114 to S117 in FIG. 8, the terminal loop is repeated while incrementing the counter m until all the terminals 10 are executed and the end position of the terminal loop is reached. Further, after the terminal loop ends, the receiving station loop is repeated while incrementing the counter k. Then, the receiving station loop and the terminal loop are repeated, and when all the receiving stations 20 are executed and the end position of the receiving station loop is reached, the series of processing is ended.

The data collection processing illustrated in FIG. 25 can be summarized as the following (A) to (C).

(A) Case where Synthesis Demodulation Fails

In a case where the synthesis demodulation fails, the annotation is not performed.

(B) Case where Synthesis Demodulation Succeeds and Single Demodulation Fails

When the synthesis demodulation succeeds and the single demodulation fails, the case is divided into two cases (I) and (II).

(I) In a case where there is another receiving station 20 that succeeds in single demodulation of the same frame, teacher data is created using the position information of the receiving station k and the other receiving station 20. From the position information of (the terminal m, the receiving station k, and other receiving stations), a straight line distance Dk [km] of (the terminal m and the receiving station k) and a straight line distance Do [km] of (the terminal m and other receiving stations) are calculated. The distance difference D [km]=Dk-Do is calculated. Assuming that the speed of light is c [km/s], a time difference Diff T=D/c [sec] for receiving the signal from the transmission terminal is calculated. By adding the time difference Diff T to the detection time Det_T_o (n) [s] of the frame n in the receiving station 20 that has been successfully demodulated as a single unit, a frame time Ans_T (n)=Det_T_o (n)+Diff T [sec], which is teacher data in the receiving station k that has failed to be demodulated as a single unit, is calculated. The annotation is performed with the reception signal as input data and the frame time Ans_T (n) as teacher data. The other receiving stations 20 can collect data corresponding to the number of frames for which single demodulation has succeeded.

(II) In a case where there is no other receiving station 20 that succeeds in single demodulation of the same frame, annotation is not performed.

(C) Case where Synthesis Demodulation Succeeds and Single Demodulation Succeeds

When the synthesis demodulation succeeds and the single demodulation succeeds, the annotation is performed with the reception signal as the input data and the detection time Det_T (n) as the teacher data. Data corresponding to the number of frames for which single demodulation has succeeded can be collected.

By the above method, even in a case where the deviation amount between repeated transmission frames is not linear or in a case where strong input interference or the like exists, teacher data can be created by combining reception results of other receiving stations 20, and effective construction of a reception model with good reception performance can be expected by supervised learning.

In addition, since it is expected that the tendency of interference varies due to a difference in use case and transmission frequency for each terminal ID, it is effective to sort effective learning data and unnecessary learning data for the current learned model by updating the learning data for each terminal ID and relearning the model. When relearning is performed without storing a certain number of collected data sets, there is a possibility that an effect does not appear in the verification data set and learning data is collected and updated while it is unclear whether the data is useful data or unnecessary data, and storing a certain number of data sets is effective for sorting learning data.

### Seventh Embodiment

In the first to sixth embodiments, in a case where there is no frame that is successfully demodulated as a single unit among the repeated frames, the reception sensitivity is used or the reception information in the other receiving station 20 is used. However, there is a problem that learning data cannot be collected in a case where a frame of which detection has failed due to a strong input interference signal or the like has the highest reception sensitivity among repeated frames, or in a case where there is no frame that is successfully demodulated as a single unit even in the other receiving stations 20.

Therefore, in the seventh embodiment, a method capable of collecting learning data by performing waveform synthesis and demodulation in all combinations of repeated frames is proposed. In the seventh embodiment, points different from the sixth embodiment will be described. Differences from the sixth embodiment are four points of a synthesis demodulation method, reception information transmitted from the receiving station 20 to the server 30, reception result list generation, and data collection.

### <System Operation>

In the DT frame reception processing illustrated in FIG. 5, it is assumed that there are 1, 2, . . . , n repeated frames. At this time, for collection of learning data, waveform synthesis and demodulation are performed on each of ₙC₂+ₙC₃+ . . . +ₙC₍ₙ₋₁₎ patterns that are combinations of selecting 2, 3, . . . , (n−1) from n, and a minimum unit of a frame combination that is successfully demodulated is searched for. For example, in a case where the number of repeated frames is 4, waveform synthesis and demodulation of 10 patterns (₄C₂+₄C₃=10) for selecting 2 and 3 from 4 are performed. As a result, in a case where the demodulation succeeds only in the combination of the frame #0 and the frame #1, the frame #0 and the frame #1 are the minimum units in which the synthesis demodulation succeeds, and it can be specified that the detection succeeds.

Furthermore, in step S24 of FIG. 4, the operation of transmitting the reception information (DT Info) from the receiving station 20 to the server 30 is different. In the seventh embodiment, information indicating whether or not each frame is a minimum unit that is successfully synthesized and demodulated is added to the reception information (DT Info).

### <Generation of Reception Result List>

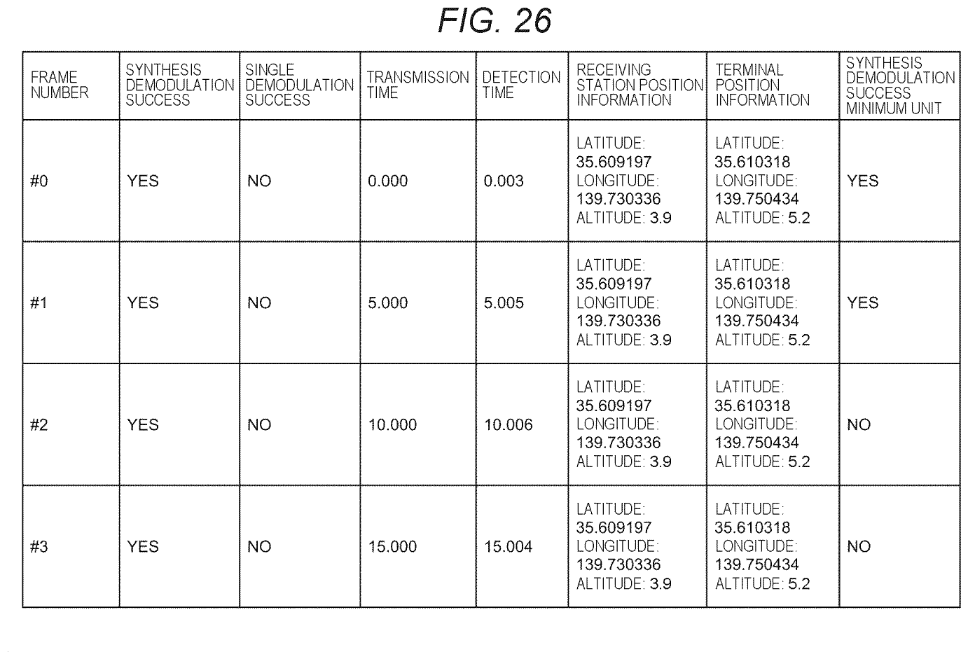

In step S35 of FIG. 4, the operation of generating the reception result list is different. Details of the processing of step S35 of FIG. 4 are illustrated in the flowchart of FIG. 6. In step S54 of FIG. 6, a reception result list as illustrated in FIG. 26 is generated for each combination of the receiving station 20 and the terminal 10.

The reception result list in FIG. 26 is generated in a case where the number of repeated frames is 4 and the relationship between the frame transmission time and the frame reception time is as illustrated in FIG. 23. In the reception result list of FIG. 26, the frame synthesis demodulation result, the single frame demodulation result, the transmission time Calc_T (n), the detection time Det_T (n), the reception position information, the terminal position information, and the synthesis demodulation success minimum unit are put together for each frame identified by the frame number.

The synthesis demodulation success minimum unit indicates whether it is included in the minimum unit of the frame combination that succeeds in synthesis demodulation. In the example of FIG. 26, the frame #0 and the frame #1 in which the synthesis demodulation success minimum unit is “YES” are the minimum units that succeed in the synthesis demodulation.

### <Data Collection>

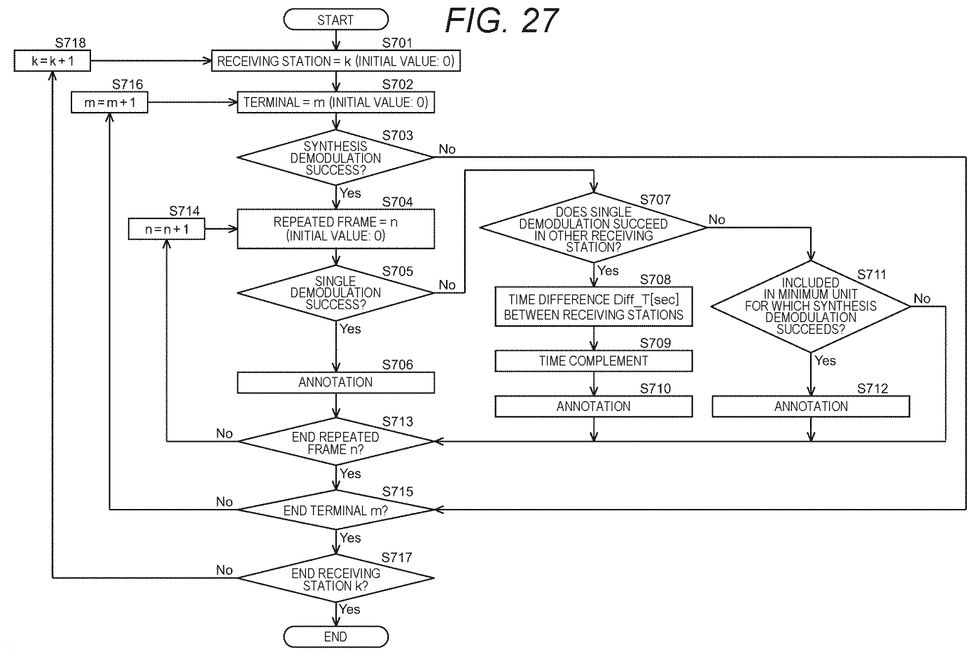

In step S36 of FIG. 4, the operation of collecting data is different. A flow of data collection processing in the seventh embodiment will be described with reference to a flowchart in FIG. 27.

In steps S701 and S702, similarly to steps S601 and S602 in FIG. 25, k=0 and m=0 are respectively set as initial values of the counter k of the receiving station loop and the counter m of the terminal loop.

In step S703, from the reception result list of the receiving station k and the terminal m, whether the synthesis demodulation succeeds in the repeated frames is checked. In step S703, in a case where the synthesis demodulation is successful, the processing proceeds to step S704. In step S704, n=0 is set as an initial value of the counter n at the start position of the frame loop.

In step S705, from the reception result list of the receiving station k and the terminal m, whether the single demodulation succeeds in the frame n is checked. In step S705, in a case where the single demodulation succeeds in the frame n, the processing proceeds to step S706. In step S706, similarly to step S606 in FIG. 25, the annotation in which the reception signal is set as the input data and the detection time Det_T (n) is set as the teacher data is performed. When the processing of step S706 ends, the processing proceeds to step S713.

On the other hand, in step S705, in a case where the single demodulation has not succeeded in the frame n, the processing proceeds to step S707. In step S707, from the reception result lists of the terminals m of all the receiving stations, it is checked whether there is a receiving station that succeeds in single demodulation of the frame n other than the receiving station k. In step S707, in a case where the single demodulation of the frame n succeeds in the other receiving station 20, the processing proceeds to step S708.

In steps S708 to S710, similarly to steps S608 to 610 in FIG. 25, the time difference Diff T [sec] between the receiving stations is calculated by the above-described Equations (11) and (12), and the time complement using the time difference Diff T is performed, so that the frame time Ans_T (n) is calculated by the above-described Equation (13). Then, annotation is performed with the reception signal as input data and the frame time Ans_T (n) as teacher data. When the processing of step S710 ends, the processing proceeds to step S713.

On the other hand, in a case where the single demodulation of the frame n is not successful in the other receiving stations 20 in step S707, the processing proceeds to step S711. In step S711, from the reception result list of the terminal m of the receiving station k, it is checked whether the frame n is included in the minimum unit in which the synthesis demodulation succeeds. In step S711, in a case where the frame n is included in the minimum unit for which the synthesis demodulation succeeds, the processing proceeds to step S712.

In step S712, the annotation in which the reception signal is set as the input data and the detection time Det_T (n) is set as the teacher data is performed. When the processing of step S712 ends, the processing proceeds to step S713. In addition, in step S711, in a case where the frame n is not included in the minimum unit for which the synthesis demodulation succeeds, step S712 is skipped, and the processing proceeds to step S713.

In steps S713 and S714, similarly to steps S611 and S612 in FIG. 25, the frame loop is repeated while incrementing the counter n until all the repeated frames are executed and the end position of the frame loop is reached. Then, in a case where (repeated frame n)=(repeated frame upper limit number−1) is satisfied in step S713, the processing proceeds to step S715. In addition, in a case where the synthesis demodulation is not successful in step S703, the processing proceeds to step S715.

In steps S715 to S718, similarly to steps S613 to S616 in FIG. 25, the terminal loop is repeated while incrementing the counter m until all the terminals 10 are executed and the end position of the terminal loop is reached. Further, after the terminal loop ends, the receiving station loop is repeated while incrementing the counter k. Then, the receiving station loop and the terminal loop are repeated, and when all the receiving stations 20 are executed and the end position of the receiving station loop is reached, the series of processing is ended.

The data collection processing illustrated in FIG. 27 can be summarized as the following (A) to (C).

(A) Case where Synthesis Demodulation Fails

In a case where the synthesis demodulation fails, the annotation is not performed.

(B) Case where Synthesis Demodulation Succeeds and Single Demodulation Fails

When the synthesis demodulation succeeds and the single demodulation fails, the case is divided into two cases (I) and (II).

(I) In a case where there is another receiving station 20 that succeeds in single demodulation of the same frame, the case is similar to the sixth embodiment.

(II) In a case where there is no other receiving station 20 that succeeds in the single demodulation of the same frame, the annotation is performed with the reception signal as the input data and the detection time Det_T (n) as the teacher data in the frame included in the minimum unit of the frame combination that succeeds in the demodulation, and the annotation is not performed in the frame not included in the minimum unit of the frame combination that succeeds in the demodulation. Data corresponding to the number of frames included in the minimum unit of a frame combination that is successfully demodulated can be collected.

(C) Case where Synthesis Demodulation Succeeds and Single Demodulation Succeeds

When the synthesis demodulation succeeds and the single demodulation succeeds, the annotation is performed with the reception signal as the input data and the detection time Det_T (n) as the teacher data. Data corresponding to the number of frames for which single demodulation has succeeded can be collected.

According to the above method, even in a case where there is no frame that is successfully demodulated as a single unit among the repeated frames or in a case where reception information in the other receiving station 20 cannot be used, teacher data can be created by synthesizing in all combinations of the repeated frames, and effective construction of a reception model with good reception performance can be expected by supervised learning.

In addition, since it is expected that the tendency of interference varies due to a difference in use case and transmission frequency for each terminal ID, it is effective to sort effective learning data and unnecessary learning data for the current learned model by updating the learning data for each terminal ID and relearning the model. When relearning is performed without storing a certain number of collected data sets, there is a possibility that an effect does not appear in the verification data set and learning data is collected and updated while it is unclear whether the data is useful data or unnecessary data, and storing a certain number of data sets is effective for sorting learning data.

As described above, according to the present disclosure, it is possible to automatically collect supervised learning data and more effectively collect learning data. In addition, since the learning data is collected for each receiving station 20, each terminal 10, and each period and the relearning of the learned model is executed, it is possible to construct a frame detector (signal detector) optimal for a place or a period in which the receiving station 20 is present. Since the learning data is collected for each receiving station 20, for each terminal 10, and for each period and the relearning of the learned model is executed, it is possible to effectively sort effective learning data and unnecessary learning data for the current learned model. Furthermore, it is possible to improve reception performance and reduce the cost of learning data collection.

### <Computer Configuration>

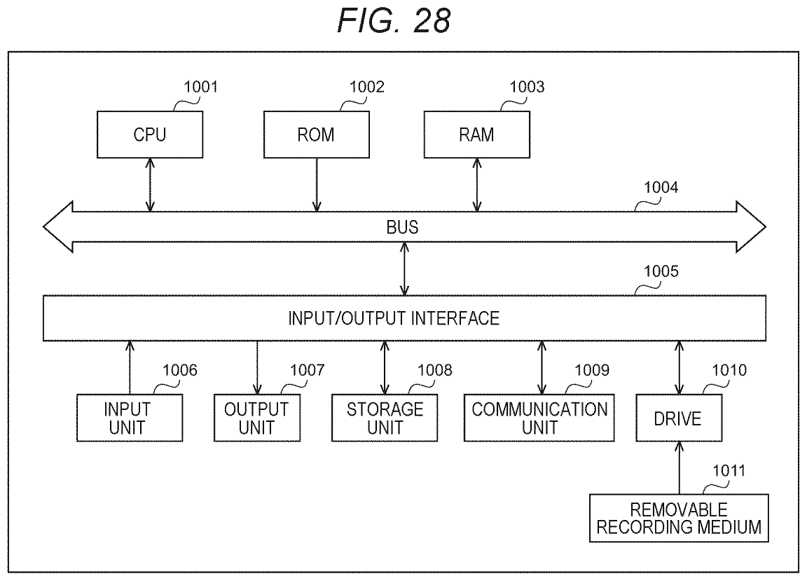

The series of processing described above can be executed by hardware and also can be executed by software. In a case where the series of processing is executed by software, a program constituting the software is installed on a computer. FIG. 28 is a block diagram illustrating a configuration example of the hardware of the computer that executes the above-described series of processing by the program.

In the computer, a central processing unit (CPU) 1001, a read only memory (ROM) 1002, and a random access memory (RAM) 1003 are mutually connected by a bus 1004. The bus 1004 is further connected with an input/output interface 1005. An input unit 1006, an output unit 1007, a storage unit 1008, a communication unit 1009, and a drive 1010 are connected to the input/output interface 1005.

The input unit 1006 includes a keyboard, a mouse, a microphone and the like. The output unit 1007 includes a display, a speaker, and the like. The storage unit 1008 includes a hard disk, a nonvolatile memory, and the like. The communication unit 1009 includes a network interface and the like. The drive 1010 drives a removable recording medium 1011 such as a semiconductor memory, a magnetic disk, an optical disk, or a magneto-optical disk.

In the computer configured as described above, the CPU 1001 loads a program recorded in the ROM 1002 or the storage unit 1008 into the RAM 1003 via the input/output interface 1005 and the bus 1004 and executes the program, so as to perform the above-described series of processing.

A program executed by the computer (CPU 1001) can be provided by being recorded on the removable recording medium 1011 as a package medium, or the like, for example. Also, the program can be provided via a wired or wireless transmission medium such as a local area network, the Internet, or digital satellite broadcasting.

In the computer, the program can be installed in the storage unit 1008 via the input/output interface 1005 by mounting the removable recording medium 1011 to the drive 1010. Furthermore, the program can be received by the communication unit 1009 via a wired or wireless transmission medium and installed in the storage unit 1008. Alternatively, the program can be installed into the ROM 1002 or the storage unit 1008 in advance.

Herein, in this specification, the processing performed by the computer according to the program is not necessarily required to be performed in time series along the order described as the flowchart. That is, the processing to be performed by the computer in accordance with the program includes processing to be executed in parallel or independently of one another (parallel processing or object-based processing, for example). Furthermore, the program may be executed by one computer (processor), or may be executed by a plurality of computers in a distributed manner.

Note that embodiments of the present disclosure are not limited to the embodiments described above, and various modifications may be made without departing from the scope of the present disclosure. Furthermore, the effects described herein are merely examples and are not limited to specific effects, and some other effects may be provided. In the present specification, a system refers to a logical assembly of a plurality of apparatuses.

Furthermore, the present disclosure can have the following configurations.

(1)

An information processing apparatus including
a data collection unit that collects supervised data of a frame that has failed to be demodulated as a single frame by using a deviation amount between a detection time and a transmission time of a frame that has been successfully demodulated as a single frame in a case where a deviation amount between a transmission time at a terminal and a reception time at a receiving station is constant between repeated frames.
   (2)

The information processing apparatus according to (1), in which
in a case where the deviation amount between the transmission time at the terminal and the reception time at the receiving station is constant between the repeated frames, and when all frames in the repeated frames fail to be demodulated as a single unit, the data collection unit collects supervised data of a frame that has failed to be demodulated as a single frame by using reception sensitivity.
   (3)

The information processing apparatus according to (2), in which
in a case where the deviation amount between the transmission time at the terminal and the reception time at the receiving station is constant between the repeated frames, and when all frames in the repeated frames fail to be demodulated as a single unit and when data cannot be collected by using reception sensitivity, the data collection unit collects supervised data of a frame that has failed to be demodulated as a single frame by using reception information of another receiving station.
   (4)

The information processing apparatus according to (1), in which
in a case where the deviation amount between the transmission time at the terminal and the reception time at the receiving station is linear between the repeated frames, the data collection unit collects supervised data of a frame that has failed to be demodulated as a single frame by performing linear regression on a transmission time and a detection time by using two or more frames that have been successfully demodulated as a single frame.
   (5)

The information processing apparatus according to (4), in which
in a case where the deviation amount between the transmission time at the terminal and the reception time at the receiving station is linear between the repeated frames, and when a frame that has been successfully demodulated as a single frame is one frame or less, the data collection unit collects supervised data of a frame that has failed to be demodulated as a single frame by using a reception time of a frame having a higher reception sensitivity than other frames.
   (6)

The information processing apparatus according to (1), in which
in a case where the deviation amount between the transmission time at the terminal and the reception time at the receiving station is not linear between the repeated frames or in a case where strong input interference exists, the data collection unit collects supervised data of a frame that has failed to be demodulated as a single frame by using reception information of another receiving station.
   (7)

The information processing apparatus according to (6), in which
the data collection unit collects supervised data of a frame that has failed to be demodulated as a single frame by performing waveform synthesis and demodulation in all combinations of repeated frames.
   (8)

The information processing apparatus according to (7), in which
the data collection unit performs waveform synthesis and demodulation in all combinations of repeated frames in a case where there is no frame that is successfully demodulated as a single unit among the repeated frames and data cannot be collected by using reception sensitivity.
   (9)

The information processing apparatus according to any one of (1) to (8), further including:
a learned model generation unit that generates a learned model; and
a relearning unit that performs relearning of the learned model by using a learning data set including the supervised data collected.
   (10)

The information processing apparatus according to (9), in which
the learned model is a frame detector that receives a reception signal as an input and outputs a time at which a frame exists.
   (11)

The information processing apparatus according to (9) or (10), in which
the learned model is provided to the receiving station, and
the relearning unit compares performance of an existing learned model provided to the receiving station with performance of a new learned model generated by executing relearning of the existing learned model using the learning data set, and updates the existing learned model to the new learned model in a case where the performance of the new learned model is not deteriorated as compared with the performance of the existing learned model.
   (12)

The information processing apparatus according to any one of (1) to (11), further including
a reception result list generation unit that generates a reception result list for each combination of the receiving station and the terminal on the basis of reception information transmitted from the receiving station,
in which the data collection unit collects supervised data on the basis of the reception result list.
   (13)

The information processing apparatus according to (12), in which
the reception information includes at least one of a reception signal from the terminal, a terminal ID of the terminal, a demodulation result in a single frame, a demodulation result in a synthesis frame, a frame transmission time, or a frame detection time.
   (14)

The information processing apparatus according to any one of (1) to (13),
the information processing apparatus being configured as a server that communicates with each of one or more of the receiving station that receives radio signals from one or more of the terminal.
   (15)

An information processing method in which
an information processing apparatus is configured to
collect supervised data of a frame that has failed to be demodulated as a single frame by using a deviation amount between a detection time and a transmission time of a frame that has been successfully demodulated as a single frame in a case where a deviation amount between a transmission time at a terminal and a reception time at a receiving station is constant between repeated frames.
   (16)

A reception apparatus configured as a receiving station that receives a radio signal from one or more terminals, the reception apparatus including
a control unit that performs control to demodulate a frame by using a reception signal from the terminal as an input and an output from a frame detector that outputs a time at which a frame exists,
in which the frame detector is learned using a learning data set including supervised data, and
the supervised data is supervised data of a frame that has failed to be demodulated as a single frame, and is collected by using a deviation amount between a detection time and a transmission time of a frame that has been successfully demodulated as a single frame in a case where a deviation amount between a transmission time at the terminal and a reception time at the receiving station is constant between repeated frames.
   (17)

The reception apparatus according to (16), in which
the control unit performs control to transmit, to a server that generates the frame detector, reception information including at least one of the reception signal, a terminal ID of the terminal, a demodulation result in a single frame, a demodulation result in a synthesis frame, a frame transmission time, or a frame detection time.
   (18)

A reception method in which
a reception apparatus configured as a receiving station that receives a radio signal from one or more terminals is configured to
perform control to demodulate a frame by using a reception signal from the terminal as an input and an output from a frame detector that outputs a time at which a frame exists,
in which the frame detector is learned using a learning data set including supervised data, and
the supervised data is supervised data of a frame that has failed to be demodulated as a single frame, and is collected by using a deviation amount between a detection time and a transmission time of a frame that has been successfully demodulated as a single frame in a case where a deviation amount between a transmission time at the terminal and a reception time at the receiving station is constant between repeated frames.

### REFERENCE SIGNS LIST

10, 10-1, 10-2 Terminal
20, 20-1, 20-2 Receiving station
30 Server
201 Control unit
202 Communication unit
301 Control unit
302 Communication unit
303 Storage unit
311 Learned model generation unit
312 Reception result list generation unit
313 Data collection unit
314 Relearning unit
1001 CPU

1. An information processing apparatus comprising
a data collection unit that collects supervised data of a frame that has failed to be demodulated as a single frame by using a deviation amount between a detection time and a transmission time of a frame that has been successfully demodulated as a single frame in a case where a deviation amount between a transmission time at a terminal and a reception time at a receiving station is constant between repeated frames.

2. The information processing apparatus according to claim 1, wherein
in a case where the deviation amount between the transmission time at the terminal and the reception time at the receiving station is constant between the repeated frames, and when all frames in the repeated frames fail to be demodulated as a single unit, the data collection unit collects supervised data of a frame that has failed to be demodulated as a single frame by using reception sensitivity.

3. The information processing apparatus according to claim 2, wherein
in a case where the deviation amount between the transmission time at the terminal and the reception time at the receiving station is constant between the repeated frames, and when all frames in the repeated frames fail to be demodulated as a single unit and when data cannot be collected by using reception sensitivity, the data collection unit collects supervised data of a frame that has failed to be demodulated as a single frame by using reception information of another receiving station.

4. The information processing apparatus according to claim 1, wherein
in a case where the deviation amount between the transmission time at the terminal and the reception time at the receiving station is linear between the repeated frames, the data collection unit collects supervised data of a frame that has failed to be demodulated as a single frame by performing linear regression on a transmission time and a detection time by using two or more frames that have been successfully demodulated as a single frame.

5. The information processing apparatus according to claim 4, wherein
in a case where the deviation amount between the transmission time at the terminal and the reception time at the receiving station is linear between the repeated frames, and when a frame that has been successfully demodulated as a single frame is one frame or less, the data collection unit collects supervised data of a frame that has failed to be demodulated as a single frame by using a reception time of a frame having a higher reception sensitivity than other frames.

6. The information processing apparatus according to claim 1, wherein
in a case where the deviation amount between the transmission time at the terminal and the reception time at the receiving station is not linear between the repeated frames or in a case where strong input interference exists, the data collection unit collects supervised data of a frame that has failed to be demodulated as a single frame by using reception information of another receiving station.

7. The information processing apparatus according to claim 6, wherein
the data collection unit collects supervised data of a frame that has failed to be demodulated as a single frame by performing waveform synthesis and demodulation in all combinations of repeated frames.

8. The information processing apparatus according to claim 7, wherein
the data collection unit performs waveform synthesis and demodulation in all combinations of repeated frames in a case where there is no frame that is successfully demodulated as a single unit among the repeated frames and data cannot be collected by using reception sensitivity.

9. The information processing apparatus according to claim 1, further comprising:
a learned model generation unit that generates a learned model; and
a relearning unit that performs relearning of the learned model by using a learning data set including the supervised data collected.

10. The information processing apparatus according to claim 9, wherein
the learned model is a frame detector that receives a reception signal as an input and outputs a time at which a frame exists.

11. The information processing apparatus according to claim 9, wherein
the learned model is provided to the receiving station, and
the relearning unit compares performance of an existing learned model provided to the receiving station with performance of a new learned model generated by executing relearning of the existing learned model using the learning data set, and updates the existing learned model to the new learned model in a case where the performance of the new learned model is not deteriorated as compared with the performance of the existing learned model.

12. The information processing apparatus according to claim 1, further comprising
a reception result list generation unit that generates a reception result list for each combination of the receiving station and the terminal on a basis of reception information transmitted from the receiving station,
wherein the data collection unit collects supervised data on a basis of the reception result list.

13. The information processing apparatus according to claim 12, wherein
the reception information includes at least one of a reception signal from the terminal, a terminal ID of the terminal, a demodulation result in a single frame, a demodulation result in a synthesis frame, a frame transmission time, or a frame detection time.

14. The information processing apparatus according to claim 1,
the information processing apparatus being configured as a server that communicates with each of one or more of the receiving station that receives radio signals from one or more of the terminal.

15. An information processing method wherein
an information processing apparatus is configured to
collect supervised data of a frame that has failed to be demodulated as a single frame by using a deviation amount between a detection time and a transmission time of a frame that has been successfully demodulated as a single frame in a case where a deviation amount between a transmission time at a terminal and a reception time at a receiving station is constant between repeated frames.

16. A reception apparatus configured as a receiving station that receives a radio signal from one or more terminals, the reception apparatus comprising
a control unit that performs control to demodulate a frame by using a reception signal from the terminal as an input and an output from a frame detector that outputs a time at which a frame exists,
wherein the frame detector is learned using a learning data set including supervised data, and
the supervised data is supervised data of a frame that has failed to be demodulated as a single frame, and is collected by using a deviation amount between a detection time and a transmission time of a frame that has been successfully demodulated as a single frame in a case where a deviation amount between a transmission time at the terminal and a reception time at the receiving station is constant between repeated frames.

17. The reception apparatus according to claim 16, wherein
the control unit performs control to transmit, to a server that generates the frame detector, reception information including at least one of the reception signal, a terminal ID of the terminal, a demodulation result in a single frame, a demodulation result in a synthesis frame, a frame transmission time, or a frame detection time.

18. A reception method in which
a reception apparatus configured as a receiving station that receives a radio signal from one or more terminals is configured to
perform control to demodulate a frame by using a reception signal from the terminal as an input and an output from a frame detector that outputs a time at which a frame exists,
wherein the frame detector is learned using a learning data set including supervised data, and
the supervised data is supervised data of a frame that has failed to be demodulated as a single frame, and is collected by using a deviation amount between a detection time and a transmission time of a frame that has been successfully demodulated as a single frame in a case where a deviation amount between a transmission time at the terminal and a reception time at the receiving station is constant between repeated frames.
